(19) United States
(12) Patent Application Publication
(10) Pub. No.: US 2024/0328653 A1
(43) Pub. Date: Oct. 3, 2024

(54) DETERMINATION OF A TEMPERATURE IN AN HVAC SYSTEM

(71) Applicant: BELIMO Holding AG, Hinwil (CH)

(72) Inventors: Yoram MOTTAS, Fribourg (CH); Fabian JÄHNING, Zürich (CH)

(21) Appl. No.: 18/735,758

(22) Filed: Jun. 6, 2024

Related U.S. Application Data
(63) Continuation-in-part of application No. PCT/EP2022/085020, filed on Dec. 8, 2022.

(30) Foreign Application Priority Data
Dec. 8, 2021 (CH) 070679/2021

(51) Int. Cl. F24F 11/523; F24F 11/64; F24F 110/10

(52) U.S. Cl. CPC F24F 11/523; F24F 11/64; F24F 2110/10

(57) ABSTRACT

A method for determining a temperature in a heating, ventilation, and/or air conditioning system includes repeatedly measuring the temperature with a temperature sensor to acquire time-resolved raw temperature data; processing the acquired raw temperature data with a correction algorithm that is configured to at least partially compensate for a response time of the temperature sensor, at least in selected time periods, using a computer processor to generate processed temperature data; and electronically outputting the processed temperature data to a user interface, a machine interface and/or a data storage medium.

### CROSS-REFERENCE

The present application is a continuation-in-part application of International (PCT) application no. PCT/EP2022/085020 filed on Dec. 8, 2022, which claims priority to Swiss patent application no. 70679/2021 filed on Dec. 8, 2021, the contents of which are fully incorporated herein by reference.

### TECHNICAL FIELD

The present invention generally relates to a method for determining a temperature in a heating, ventilation, and/or air conditioning (HVAC) system with (using) a temperature sensor. Another aspect of the present invention generally relates to a device of an HVAC, preferably, a room unit, comprising means adapted to execute the method for determining a temperature. Furthermore, the present invention generally relates to a computer program comprising instructions to cause the device to execute the steps of the method for determining a temperature.

### BACKGROUND ART

Heating, ventilation, and air conditioning (HVAC) systems are in use in many public buildings, such as schools, shops, industrial buildings, in office buildings as well as in private homes. Such systems usually comprise sensors, which measure certain parameters of air, coolants or heating fluids circulating in the HVAC system.

For example, sensors of HVAC systems measure certain air parameters in a room, space or zone to be controlled, such as ambient temperature, relative humidity and/or the CO₂ content, in order to provide the parameters to a control unit, e.g. a central control unit, of the HVAC system and/or to display it to a user.

In particular, such sensors are included in a room unit, in particular a room control unit or a room sensor, in each controlled room, space or zone of the building, which enables users to measure and/or set the respective values. Typically, room units for HVAC systems are mounted to a wall of a building in the controlled room, space or zone. The room units may further comprise screens to display information concerning the set values and the measured parameters.

However, it is an issue with temperature sensors, preferably if they are included in rather small devices such as e.g. room units, that the heat generated by microprocessors or other electronic components, which are required to operate the temperature sensor, can affect temperature measurement such that the temperature measured may not accurately reflect the real temperature, e.g. the ambient room temperature. In order to reduce this undesired effect, temperature sensors frequently are thermally isolated from the other electronic components.

In this regard, U.S. Pat. No. 8,197,130 B2 (Siemens) describes for example a temperature sensing device having a housing comprising thermally isolating partition walls at (on) the inside that are configured to thermally isolate the temperature sensor from the residual (other) electronic components. Additionally the printed circuit board of the unit comprises a machined slot between the temperature sensor and the residual electronic components for reducing heat transfer through the printed circuit board.

Nevertheless, thermal isolation of the temperature sensor might still negatively affect response times of the temperature sensor when temperatures changes occur.

Likewise, when measuring temperatures in fluid lines, ducts, valves, fluid reservoirs, heating units or a cooling unit of a HVAC system, similar problems may arise.

Thus, there is still a need to develop improved solutions for HVAC systems, which at least partly overcome the disadvantages mentioned above.

### SUMMARY

It is one non-limiting object of the preset teachings to provide improved techniques for determining the temperature in heating, ventilation, and air conditioning (HVAC) systems. The present techniques enable a determination of rapid and strong temperature changes as precisely and as fast as possible. Thereby, the implementation and setup can be kept as simple as possible. In some applications of the present teachings, rapid and strong temperature changes can be determined with a room unit in a controlled room, space or zone of a building.

In a first exemplary embodiment of the present teachings, a method for determining a temperature in a heating, ventilation, and/or air conditioning system comprises:
a) repeatedly measuring the temperature with (using) a temperature sensor to acquire time-resolved raw temperature data;
b) processing the acquired raw temperature data with a correction algorithm that is configured to at least partly compensate for a response time of the temperature sensor, at least in selected time periods, preferably using a computer processor, to provide processed temperature data; and
c) making available (electrically outputting) the processed temperature data via (to) a user interface, via (to) a machine interface and/or on (to) a data storage medium.

Such a method enables a determination of the temperature in a heating, ventilation, and/or air conditioning system in a highly precise and fast manner. This even when using ordinary room temperature sensors having rather slow response times. Thus, thanks to the above-mentioned processing of the raw temperature data acquired by the temperature sensor with (using) a correction algorithm, the method can be used to determine rapid and strong temperature changes in a reliable manner suitable for applications in HVAC systems. Optionally, the temperature which is repeatedly measured may be an ambient temperature, e.g., of a room which is connected to the heating, ventilation and/or air conditioning system. The raw temperature data may therefore optionally correspond to an ambient temperature.

Furthermore, such a method does not require a special hardware setup. In contrast, it can be implemented with any kind of temperature sensors in all kinds of HVAC setups or environments. Therefore, such a method is highly flexible.

It comes with great surprise that these advantages can be achieved directly with a correction algorithm for the response time of the temperature. Namely, in contrast to other applications, HVAC systems are subject to special conditions with regard to the temperatures to be measured, their changes over time and the precision required.

Preferably, the temperature determined in the heating, ventilation, and/or air conditioning system is determined with a room unit, at a fluid line, at a duct, at a valve, at a fluid reservoir, at a heating unit and/or at a cooling unit of a HVAC system.

The “response time of the temperature sensor” is meant to be the time it takes for the sensor to reach 63% of the final value when there is an instantaneous change in temperature, e.g. an increase of 4° C. The response time becomes significant when accurate control is needed. E.g., when an HVAC system is controlled by (using) a feedback signal of the temperature sensor, the system will typically not be able to react to changes faster than the response time of the temperature sensor. For this reason, rapid and transient changes may not be recognized if the response time is too long.

“Repeatedly measuring the temperature” means, in particular, that the temperature is measured many times, e.g. at least 10 times, in particular at least 100 times, preferably at least 1000 times, in particular at least 10000 times, or as long as the temperature sensor is being operated. For example, an average measurement frequency can be chosen in the range of 0.03-100 Hz, preferably 0.07-2 Hz, in particular 0.1-10 Hz or 0.14-0.33 Hz. Thereby, the time intervals between individual measurements can be equidistant and/or irregular. In particular, the measurement of the temperature in step a) takes place at equidistant time intervals, e.g. at time intervals of 0.1-30 seconds, preferably 0.5-15 seconds, in particular 1-10 seconds or 3-7 seconds.

The response time of the temperature sensor is compensated for at least in selected time periods. This means that the compensation might take place in selected time periods only, whereas in other time periods there is no compensation for the response time of the temperature sensor. The selected time periods can for example be defined based on a predefined parameter, based an external signal and/or can be time-controlled. However, it is possible as well that the compensation takes place all the time or during all time periods.

At least in the selected time periods, the response time of the temperature sensor is at least partly compensated. This means that the response time of the temperature sensor is reduced, e.g. by at least 5%, preferably at least 10%, in particular at least 20%, for example at least 30%, particularly at least 50% or at least 60%. For example, the response time of the temperature sensor is reduced by 5-75%, in particular by 10-65%.

The user interface can in particular comprise a display, e.g. a segment display, an analogue display, a bar display, and/or a dot-matrix display. Preferably, the display comprises an electronic paper display, preferably covered with a transparent cover. This enables temperature data, information concerning set values and optionally further parameters to be displayed.

If a display is present, the display is preferably a touchscreen or is overlaid with a touch sensitive foil. Such a display can be used as an input device for users to set values, such as e.g. a desired room temperature, ventilation intensity, etc.

A machine interface is meant to be an interface for transferring the temperature data, and optionally further data, to another device. Preferably, the machine interface is a bidirectional interface, which is configured for sending and receiving data. The machine interface can be selected from wired and/or wireless interfaces. Wireless interfaces can e.g. be selected from short-range wireless communication modules.

A data storage medium can be part of the temperature sensor and/or part of the electronics used to operate the temperature sensor. Preferably, the data storage medium, if present, is included in the room unit. A data storage medium can be used to locally store the temperature data for evaluation at a later time and/or for use as data backup, e.g. in case of disruptions of a machine interface.

Preferably, the processed temperature data can be made available (electronically output) in step c) via (to) more than one option simultaneously. For example the processed temperature data can be made available in step c) via a user interface and via a machine interface simultaneously, or via a user interface and on a data storage medium simultaneously, or via a machine interface and on a data storage medium simultaneously, or via the user interface and via a machine interface and on a data storage medium simultaneously.

In particular, the raw temperature data is acquired in the form of a dataset comprising a plurality of raw temperature values in chronological order and/or comprising a plurality of data points each including a raw temperature value and an associated time stamp. Thereby, the dataset represents the temporal evolution of the raw temperature, which can be used for processing the raw temperature data in step b). In particular, this approach enables historical raw temperature data to be considered in step b), which turned out to be highly beneficial.

In case the dataset comprises the plurality of raw temperature values in chronological order without any time stamp, the dataset might further comprise the time interval between the individual raw temperature data in order to obtain the temporal evolution of the raw temperature. However, if there is a fixed time interval, the time associated with an individual raw temperature data can be calculated directly.

In a further preferred implementation, a statistical parameter, preferably the variance, of a set of several most recent temperature values from the raw temperature data is calculated and the correction algorithm is configured such that:
(i) in time periods in which the statistical parameter, preferably the variance, of the set is equal to or above (greater than) a predefined threshold, the acquired raw temperature data is at least partially compensated for the response time of the temperature sensor in step b); and
(ii) in other time periods, in which the statistical parameter, preferably the variance, of the set is below (less than) the predefined threshold, the acquired raw temperature data in step b) is less compensated for the response time of the temperature sensor than under item (i), or the acquired raw temperature data in step b) is not compensated at all for the response time of the temperature sensor.

In another preferred implementation, a statistical parameter, preferably the variance, of a set of several most recent temperature values from the raw temperature data is calculated and the correction algorithm is configured such that:
(i) in time periods in which the statistical parameter, preferably the variance, of the set is below (less than) a predefined first threshold, the acquired raw temperature data in step b) is compensated for the response time of the temperature sensor according to a first compensation function or the acquired raw temperature data in step b) is not compensated at all for the response time of the temperature sensor;
(ii) in time periods in which the statistical parameter, preferably the variance, of the set is equal to or higher (greater than) than the predefined first threshold and lower (less) than a predefined second threshold, the acquired raw temperature data is compensated for the response time of the temperature sensor in step b) according to a second compensation function; and
(iii) in time periods, in which the statistical parameter, preferably the variance, of the set is equal to or above (greater than) the predefined second threshold, the acquired raw temperature data is compensated for the response time of the temperature sensor in step b) according to a third compensation function.

Thereby, in particular, the first, second and third compensation functions are different.

The statistical parameter can e.g. be selected from an arithmetic mean, geometric mean, harmonic mean, the standard deviation and/or the variance of a set of several most recent temperature values from the raw temperature data. Thereby, the set of several most recent temperature values from the raw temperature data preferably comprises at least 5, in particular at least 10, preferably at least 100, for example at least 1000, individual raw temperature data.

Considering statistical parameters allows for discriminating between time periods with strong temperature changes and time periods with more constant temperatures. This makes it possible to optimize the response time compensation to the specific needs in a given time period. Overall, the response time compensation can be performed more efficiently with this approach.

As it turned out, the variance is a highly meaningful parameter in this context. The variance is the square of the standard deviation.

The threshold can be set according to the specific requirements of the HVAC system.

In a further preferred implementation, the raw temperature data as acquired in step a) and/or the processed temperature data of step b) in addition are converted with a further correction algorithm that is configured to at least partially compensate for self-heating of the temperature sensor.

Thereby, preferably, a self-heating temperature is calculated and subtracted from the raw temperature data acquired in step a) and/or from the processed temperature data of step b).

In particular, the compensation for the self-heating is calculated taking into account at least one environmental parameter, preferably at least two environmental parameters. The at least one environmental parameter preferably is selected from ambient temperature, supply voltage, humidity, and/or airflow.

Preferably, the at least one external (environmental) parameter is selected from ambient temperature and/or supply voltage, most preferably the at least one external parameter comprises at least two external parameters: especially preferred are the ambient temperature and the supply voltage.

For the ambient temperature, the most recent raw temperature or the most recent processed temperature can be used.

The supply voltage is meant to be a supply voltage of a device of the heating, ventilation, and/or air conditioning system, preferably a device of the HVAC system that comprises the temperature sensor. The device in particular is a room unit.

Preferably, the supply voltage is estimated based on an internal voltage of the device of the heating, ventilation, and/or air conditioning system, preferably the room unit. The internal voltage is meant to be the internal supply voltage at which the device of the HVAC system is operated.

The further correction algorithm in particular is configured such that the compensation is linearly dependent on the at least one environmental parameter, preferably linearly dependent on at least two environmental parameters.

Preferably, the further correction algorithm is configured such that the self-heating temperature T_{SH} is calculated according to the following formula (I):

$${T}_{SH} ( y , z ) = {p}_{00} + {p}_{10} y + {p}_{01} z \qquad ( I )$$

wherein:
p₀₀, p₁₀, and p₀₁ are constant coefficients;
y is a first environmental parameter, preferably the ambient temperature;
z is a second environmental parameter, preferably the supply voltage;
   and wherein the calculated self-heating temperature T_{SH} is subtracted from the raw temperature data acquired in step a) and/or from the processed temperature data of step b).

The constant coefficients p₀₀, p₁₀, and p₀₁ in particular are determined experimentally.

Self-heating of the temperature sensor may taint the temperature measured by the temperature sensor: i.e. the measured temperature may differ from the ambient temperature. Using the further correction algorithm, the influence of self-heating on the measured temperature may be reduced.

In particular, at least one or all parameters of the further correction algorithm, preferably the constant coefficients p₀₀, p₁₀, and/or p₀₁, is/are selected and/or set depending on the specific environment in which the temperature sensor is located, in particular depending on the type and/or configuration of the room unit in which the temperature sensor is placed.

This approach enables a reliable and precise self-heating compensation.

Preferably, in time periods other than the selected time periods of step b) in which the acquired raw temperature data is processed with the correction algorithm, the processed temperature in step b) is set equal to the raw temperature data and/or to the raw temperature data processed with the further correction algorithm. Most preferably, the processed temperature in step b) is set equal to the raw temperature data processed with the further correction algorithm.

When implementing this feature, there is always temperature data that can be made available in step c) via the user interface, via the machine interface and/or on the data storage medium. Thus, for example, a central processing unit of the HVAC system can constantly be fed with temperature data.

Preferably, steps a) and b) take place in essence simultaneously, preferably steps a), b) and c) take place in essence simultaneously.

In particular, the correction algorithm that is configured to at least partially compensate for the response time of the temperature sensor is a recursive filter. This is meant to be a filter which re-uses one or more of its outputs as an input. Surprisingly, recursive filters turned out to be highly beneficial for compensating for the response time of the temperature sensors that are usually used in HVAC systems.

Preferably, at least in the selected time periods, a latest value of the processed temperature data is calculated based on:
(i) the latest value of the time-resolved raw temperature data or the latest value of the time-resolved raw temperature data processed with the further correction algorithm, and
(ii) at least one previous temperature value of the processed temperature data and/or at least one previous temperature value of the time-resolved raw temperature data or at least one previous temperature value of the time-resolved raw temperature data processed with the further correction algorithm.

In particular, the latest value u_{c}(n) of the processed temperature data is calculated based on the following formula (II):

$${u}_{c} ( n ) = {a}_{0} x ( n ) + {a}_{1} x ( n - 1 ) + {b}_{1} {u}_{c} ( n - 1 ) \qquad ( II )$$

wherein:
a₀, a₁ and b₁ are recursion coefficients;
x(n) is the latest value of the time-resolved raw temperature data or the latest value of the time-resolved raw temperature data processed with the further correction algorithm;
x(n−1) is the previous value of the time-resolved raw temperature data or the previous value of the time-resolved raw temperature data processed with the further correction algorithm; and
u_{c}(n−1) is the previously calculated temperature value.

Preferably, the recursion coefficients a₀, a₁ and b₁ are determined by (i) the temperature response time of temperature sensor in a given environment, (ii) a sampling rate of the temperature sensor and/or (iii) a desired accelerator factor of the response time of the temperature response time of temperature sensor.

Specifically, a₀, a₁ and b₁ in particular are defined according to the following formulas (III), (IV), and (V):

$${a}_{0} = \frac{2 T + {T}_{S}}{2 α T + {T}_{S}} \qquad ( III )$$

$${a}_{1} = \frac{2 T - {T}_{S}}{2 α T + {T}_{S}} \qquad ( IV )$$

$${b}_{1} = \frac{2 α T - {T}_{S}}{2 α T + {T}_{S}} \qquad ( V )$$

wherein:
T=temperature response time of the temperature sensor in a given environment;
T_{S}=sampling rate of the temperature sensor; and
α=accelerator factor, wherein 0<α<1.

Typically, T, T_{S} and α are chosen as follows: T=5-30 minutes, for example 12-20 minutes; T_{S}=0.5-30 seconds, for example 1-10 seconds; and α=0.1-0.9, for example 0.4-0.7.

In particular, at least one or all parameters used in the correction algorithm, preferably the recursion coefficients, the accelerator factor α, the sampling rate T_{S} and/or the temperature response time T, is/are selected and/or set depending on the specific environment in which the temperature sensor is located.

For example, at least one or all parameters used in the correction algorithm is/are selected and/or set depending on the room size, the position of the sensor in the room, the room occupancy and/or the type and/or configuration of the room unit in which the temperature sensor is placed. This enables a temperature correction, which is adapted to the particular situation and/or to the preferences of a user, to be obtained.

However, in another possible implementation, at least one or all parameters used in the correction algorithm is/are set independently of the specific environment in which the temperature sensor is located.

The at least one or all parameters in particular is/are determined experimentally and/or set manually. Preferably, the parameters are changed if the specific environment in which the temperature sensor is located changes and/or if a user desires so.

For example, manually setting at least one or all of the parameters, e.g. the acceleration factor α, enables the correction algorithm to be adjusted to specific preferences of a user and/or to a given situation.

The acceleration factor α may optionally be determined as the output of a function having as an input a statistical parameter of a set of several most recent temperature values from the raw temperature data. More specifically, the acceleration factor α may be determined as the output of a function having as an input the variance of the set of the several most recent temperature values.

More specifically, the function for determining the acceleration factor α may comprise thresholds, e.g., two thresholds, and the function may comprise instructions for comparing the variance with the thresholds. The thresholds may be pre-set or changed dynamically, e.g., to adjust to changing environmental conditions. The thresholds may subdivide the real line into distinct compartments, and depending on in which compartment the variance falls, the acceleration factor α may be set to a different value.

For example, in case of two thresholds, if the variance is smaller than the smaller threshold, e.g., equal to ‘0.002’, of the two thresholds, the acceleration factor α may be set to a first constant value, e.g., ‘1’, and if the variance is larger than the larger threshold, e.g., equal to ‘0.25’, of the two thresholds, the acceleration factor α may be set to a second constant value, e.g., ‘0.31’, and in the remaining case the acceleration factor α may be determined as α=C₁e^{-C}^{₂}^{V}+C₃e^{-C}^{₄}^{V}, with C₁ a constant, e.g., equal to ‘0.31’, C₂ a constant, e.g., equal to ‘90’, C₃ a constant, e.g., equal to ‘0.66’, C₄ a constant, e.g., equal to ‘3’, and V corresponding to the variance provided to the function as an input.

The acceleration factor α may be determined automatically. Specifically, a sequence of acceleration factors α may be determined based on a sequence of equal length comprising variances, wherein each sequence element may be determined as was just described using the corresponding variance in the sequence of variances.

For example, a device of a heating, ventilation, and/or air conditioning system, e.g. a room unit, comprising means adapted to execute any of the above- or below-described methods may be configured such that at least one or all parameters used in the correction algorithm, preferably the recursion coefficients, the accelerator factor α, the sampling rate T_{S} and/or the temperature response time T, can be automatically and/or manually selected and/or set depending on the specific environment in which the temperature sensor is located.

The at least one or all parameters can e.g. be set directly on the device of the heating, ventilation, and/or air conditioning system, e.g. on the room unit, e.g. via a user interface, such as for example a control panel, touch sensitive displays, switches, buttons and/or rotary knobs.

In addition or alternatively, the at least one or all parameters can e.g. be set via a machine interface and/or connection means of a device of a heating, ventilation, and/or air conditioning system, e.g. a room unit.

For example, if the machine interface comprises a wireless communication module, e.g. a Wi-Fi module, a near field communication module (NFC), a Bluetooth module, a Bluetooth low energy module (BLE), and/or an ultra-wide band module (UWB), the parameters can be set with (using) an external device, e.g. a mobile device such as a mobile phone.

In another example, if the machine interface comprises a wired communication interface and/or connection means to connect the device to the HVAC system, such as e.g. for a Multi Point Bus (MP-Bus), a Modbus, a Building Automation and Control Network (BACnet), and/or a KNX system, the parameters can be set with (using) an external control unit via the wired interface and/or connection means.

According to another preferred implementation, the correction algorithm is implemented with an artificial neural network.

A second aspect of the first exemplary embodiment is directed to a device of a heating, ventilation, and/or air conditioning system comprising means adapted to execute the steps of the method as described above or below. Thereby, the means in particular are adapted to execute the method with one or more, preferably all, of the optional features as described above.

In particular, the “means adapted to execute the steps of the method as described above or below” comprise (i) a temperature sensor, (ii) a controller configured for executing the steps of the method as described above or below, and (iii) a user interface, a machine interface and/or a data storage medium for making available the processed temperature data. Thereby, the controller in particular comprises a program with instructions to cause the device to execute the steps of any of the above- or below-described methods.

For example, the device of the heating, ventilation, and/or air conditioning system, e.g. a room unit, is configured such that at least one or all parameters used in the correction algorithm, preferably the recursion coefficients, the accelerator factor α, the sampling rate T_{S} and/or the temperature response time T, can be automatically and/or manually selected and/or set depending on the specific environment in which the temperature sensor is located.

In particular, if the controller is configured to perform the above-described further correction algorithm, the device is configured such that at least one or all parameters of the further correction algorithm, preferably the constant coefficients p₀₀, p₁₀, and/or p₀₁, can be automatically and/or manually selected and/or set depending on the specific environment in which the temperature sensor is located, in particular depending on the type and/or configuration of the room unit in which the temperature sensor is placed.

Preferably, the device is a room unit for an HVAC system. Preferably, the room unit comprises:
a) a housing, preferably comprising a mounting plate for mounting the room unit on a wall of a building;
b) a connection means to connect the device to the HVAC system;
c) at least one temperature sensor to measure the temperature of ambient air; and
d) a controller configured for carrying out any of the methods as described above or below.

As understood in the present application, a room unit is a device which is placed in a room, a space or a zone of a building having an HVAC system in order to supply data to the HVAC system, in particular to relay values set by a user on the room unit to the HVAC system and/or to relay current air parameters measured in a room, space or zone to the HVAC system. For example, the HVAC system then changes its operating parameters, e.g., to match the set values for the particular room, space or zone. Thus, in the present context, the term “room unit” is to be interpreted broadly and encompasses room control units as well as room sensors.

Preferably, the controller is arranged on a printed circuit board. Typical printed circuit boards are robust and can be fixed in the housing in a space saving manner.

Furthermore, in addition to the temperature sensor, the room unit preferably further comprises at least another sensor to measure at least one further parameter of ambient air, preferably humidity, the concentration of CO₂, volatile organic compounds (VOC) and/or particulate matter.

More preferably, the room unit comprises:
a) the controller arranged on a first printed circuit board; and
b) the at least one temperature sensor to measure the temperature of ambient air, wherein the at least one temperature sensor is arranged on a frontside of a second printed circuit board: wherein the second printed circuit board protrudes from the first printed circuit board, preferably in a direction perpendicular to the first printed circuit board:
   wherein the second printed circuit board is arranged such that a backside of the second printed circuit board is in physical contact with an inner surface of the housing.

The combination of the at least one temperature sensor arranged on a frontside of a second printed circuit board, which protrudes from the first printed circuit board and which is in physical contact via its backside with the inner surface of the housing, turned out to be highly beneficial. With this setup the temperature sensor is thermally decoupled from the heat generating elements, e.g. microprocessors or other electronic components, which are part of the controller of the room unit. At the same time, the temperature of the housing of the room unit, which in essence corresponds to the temperature of the ambient air in the controlled room, space or zone is efficiently coupled to the second printed circuit board or the temperature sensor. In combination with any of the methods as described above or below, this enables even faster response times to be obtained when temperatures changes occur in the controlled room, space or zone.

Moreover, this setup can accurately measure the ambient room temperature in essence independently of the heat evolution of the controller on the first printed circuit board.

Furthermore, this arrangement is obtainable with established standard assembly methods for printed circuit boards. Put differently, there is no need for complex manufacturing processes or even manual labor. Hence, this arrangement can be produced in a highly efficient and cost effective manner.

Preferably, the second printed circuit board is fixed, preferably soldered onto and/or plugged into, the first printed circuit board, in particular with at least one or more pin connectors. Preferably, there are at least two, three, or more pin connectors. Pin connectors preferably are electrical connectors. This enables a compact and mechanically stable connection between the two circuit boards. However, other setups are possible as well.

According to a preferred embodiment, the backside of the second printed circuit board comprises a heat conductive coating, which is in contact with the inner surface of the housing. In this case, the heat conductive coating of the second printed circuit board acts as a thermal bridge between the second printed circuit board and the housing. This greatly enhances the thermal coupling between the housing and the second printed circuit board or the temperature sensor, which in turn improves response times when temperatures changes occur in the controlled room, space or zone.

However, depending on the specific application, the coating can be omitted in order to simplify the setup.

Preferably, the heat conductive material is a material having a thermal conductivity (2) of at least 10 W/(m·K), preferably at least 100 W/(m·K), in particular at least 200 W/(m·K), wherein the thermal conductivity is measured at 0° C., at a pressure of 1.013 bar and a humidity of 50%.

Preferably, the heat conductive material is a metallic material, in particular comprising or consisting of copper, aluminum, silver and/or gold. These materials exhibit a relatively high thermal conductivity while being mechanically and chemically stable for use as a coating in the room unit. Nevertheless, other materials can be suitable as well.

If present, the coating of the heat conductive material preferably covers at least 50%, preferably at least 75%, in particular at least 90%, of the backside area of the second printed circuit board.

Preferably, the thickness of the coating of the heat conductive material is 0.001-1 mm, preferably 0.01-0.5 mm, in particular 0.02-0.05 mm.

This results in a highly effective thermal coupling between housing and second printed circuit board. However, the area share (ratio, portion) of the heat conductive coating can be below (less than) 50% and/or the thickness can be chosen differently, if desired for specific embodiments.

According to a further preferred embodiment, at least one humidity sensor to measure the humidity of ambient air is additionally arranged on the second printed circuit board. Also for these kinds of sensors, reliable temperature conditions are important. Of course, the second printed circuit board might comprise further sensors.

In particular, a combined sensor for measuring temperature and humidity of ambient air is arranged on the second printed circuit board. This results in a space-saving structure and an easier readout of the sensors.

Preferably, the at least one temperature sensor, the at least one humidity sensor and/or the combined sensor is an active sensor. In the present context, an active sensor is meant to be a sensor device that is powered with input energy from a source other than that which is being sensed for delivering an output signal. In contrast, a passive sensor works without input energy. If desired, the present teachings can be implemented with passive sensors as well.

In a further preferred embodiment, a further sensor for measuring a further parameter of ambient air is arranged on the first printed circuit board: preferably, the further sensor is a sensor for measuring the concentration of CO₂, volatile organic compounds (VOC) and/or particulate matter. These kinds of sensors typically produce a considerable amount of heat during operation. Therefore, it is beneficial to arrange them on the first printed circuit board, i.e. thermally decoupled from the second printed circuit board that comprises the temperature sensor.

However, a further sensor for measuring a further parameter of ambient air arranged on the first printed circuit board sensors is optional.

Preferably, the second printed circuit board is located at an edge of the first printed circuit board. This enables the second printed circuit board to directly contact the inner surface of the housing by placing the first printed circuit board nearby the inner surface. Additionally, the second printed circuit board can be separated as far as possible from the heat generating components on the first printed circuit board. However, other setups are possible as well. For example, the second printed circuit board can be located on a more central section of the first printed circuit board. In this case, the housing might feature an inner bulge for contacting the second printed circuit board.

Preferably, with reference to an installed state of the room unit,
the controller is spaced in the horizontal direction from the second printed circuit board, wherein, preferably, in the horizontal direction the controller is located in the other half of the first printed circuit board than the second printed circuit board; and/or
the controller is spaced in the vertical direction from the second printed circuit board, wherein, preferably, the controller is located above the second printed circuit board; and/or
the second printed circuit board is located in a lower half of the first printed circuit board; and/or
if present, the further sensor for measuring a further parameter of ambient air, with reference to an installed state of the room unit, is arranged in a section of the first printed circuit board in the vertical direction above the second printed circuit board.

With these measures, the second printed circuit board can optimally be separated from heat generating components on the first printed circuit board. Thereby, if the second printed circuit board is located in the vertical direction below the heat generating components, ascending heat produced by these components will not flow around the second printed circuit board. Nevertheless, other setups are possible as well.

Preferably, in a first section of the first printed circuit board, in which the second printed circuit board is installed,
there is no metallic ground plane on or within the first printed circuit board; and/or
a surface area of metallic connection lines and/or metallic ground planes on or within the first printed circuit board is below (less than) 50%, preferably below 25%, in particular below 10%, relative to the total surface area of the first section; and/or
the first section is separated from a second section of the first printed circuit board, in which the controller is located, by at least one slit-shaped opening in the first printed circuit board, preferably for thermally decoupling the two sections.

In a further preferred embodiment, the first printed circuit board comprises a third section in which the at least one further sensor is located, wherein the third section is separated from the first and/or the second section by at least one further slit-shaped opening in the first printed circuit board, preferably for thermally decoupling the third section from the first and/or the second section.

In the embodiments described above, the first section preferably has a surface share (ratio, portion) of 5-50%, preferably 7-30%, in particular 10-20%, relative to the total surface area of the first printed circuit board.

These measures, each one alone and even more in combination with each other, help to further thermally decouple the second printed circuit board from the first printed circuit board.

Preferably, the housing frame comprises a support structure, preferably a tray, for carrying (supporting) the controller or the printed circuit board, preferably the first printed circuit board, with the controller arranged on it within an inner volume surrounded by the side wall, preferably on a side of the support structure facing away from the wall and/or the mounting plate.

The support structure preferably defines a fixed position of the circuit boards in the housing. If the support structure is present in the above-mentioned housing frame, the first printed circuit board with the second printed circuit board can be installed beforehand on the support structure and later on attached to the mounting plate. This greatly simplifies installation and maintenance.

Preferably, the support structure covers 50-100%, preferably 70-90%, of the cross-sectional area of the inner volume surrounded by the side wall of the housing frame. This enables the housing to be divided into two distinct volumes, such that, for example, the circuit boards can be protected against undesired forces during installation.

The printed circuit board, preferably the first printed circuit board, preferably comprises one or more pin connectors, in particular for connecting the controller to the connection means.

In this case, preferably, the mounting plate comprises the connection means to connect the device to the HVAC system, preferably a connector for a bus system, preferably a field bus system, and/or a socket which is configured for receiving the one or more pin connectors of the printed circuit board, preferably the first printed circuit board.

Most preferably, the pin connectors of the printed circuit board, preferably the first printed circuit board, and the connection means are configured such that the one or more pin connectors can be inserted or are inserted into the socket, preferably through openings in the support structure, preferably in a direction perpendicular to the mounting plate.

This enables an easy and safe installation since the printed circuit board, preferably the first printed circuit board, can simply be pressed on the connection means for establishing a connection.

The front housing part preferably is a separate part of the housing which is configured to be fixed on the housing frame, preferably with at least one snap-in connector.

According to a preferred embodiment, the front housing part comprises a display, preferably an electronic paper display, preferably covered with a transparent cover. This enables information concerning the set values and the measured parameters, such as the corrected temperature data, to be displayed.

Preferably, the display is a touchscreen or is overlaid with a touch sensitive foil. Such a display can be used as an input device for users to set values, such as e.g. a desired room temperature, ventilation intensity, etc.

In another preferred embodiment, the front housing part is a blind cover. In this case, no display is present and the room unit is intended to function without user input, or user input is provided via other input devices, e.g. wireless communication modules.

Furthermore, the room unit preferably comprises a short-range wireless communication module which enables wireless communication with a mobile device for the exchange of data between the mobile device and the room unit, and vice versa.

Further preferred, the room unit comprises an antenna for wireless communication, preferably, an antenna of the above mentioned short-range wireless communication module.

Most preferably, the antenna is arranged behind the display, preferably in physical contact with the backside of the display. In particular the antenna can be in loose contact with the display, or the antenna is attached to a backside of the display. In a special embodiment, the antenna is materially bonded to the backside of the display, preferably adhesively bonded to the backside of the display.

Arranging the antenna behind the display turned out to be highly beneficial. Thereby the antenna can be attached to the backside of the display. This simplifies installation and protects the antenna during installation and maintenance. Nevertheless, electromagnetic waves typically used for short-range wireless frequencies sufficiently penetrate displays that are usually used for room units. Additionally, the antenna is optimally placed in the room unit for establishing a reliable connection with a mobile device. As it turned out, users intuitively tend to hold a mobile device in front of a display. Thus, if the antenna is located behind the display, the chances of obtaining a reliable connection in a first attempt are highly improved. The arrangement of the antenna behind the display therefore results in a synergistic effect.

If the front housing part is a blind cover, the antenna preferably is in physical contact or attached to the backside or the inner side of the blind cover.

Preferably the antenna is a planar antenna, preferably a microstrip antenna and/or a foil antenna, in particular comprising conductive antenna elements in and/or on a substrate in the form of a plastic foil. Such antennas are rather robust and compact.

Preferably, the outer dimensions of the antenna are equal to or smaller than the size of the display. Thus, in this case the antenna is fully covered by the blind cover or the display, resulting in maximum protection.

According to a further preferred embodiment, the antenna is a planar frame-shaped antenna, preferably having a shape and an outer dimension equal to the outer dimension of the display or the inner dimension of the blind cover. Antennas having such shapes can cover the whole area of the front housing part and/or the display and ensure a good connection with a mobile device even if it is positioned at (along) an edge of the housing and/or display.

In another embodiment, the antenna can have the form of a planar rectangular sheet.

Further preferred, the front housing part comprises a frame element for carrying (supporting) the display, the transparent cover, the touch sensitive foil, and/or the antenna, wherein, preferably, the frame element comprises snap-in connection means for connecting the frame element to the housing frame. Such a frame element supports and protects the stack of components.

Preferably, the controller comprises a microcontroller or a microprocessor, as well as at least one memory. In the installed state, the controller is in particular electrically connected to the connection means, preferably via the pin connectors. If present, the controller furthermore can be connected to the display, the second printed circuit board, the at least one temperature sensor and/or the at least one further sensor.

In particular, the controller is further configured to send data to and receive data from the HVAC system. Additionally, the controller can be configured to present data on the display, if present, and/or to read data from an input device, if present. The data comprises for example temperature data, humidity data, CO₂ data, data on particulate matter and/or ventilation data.

In another preferred embodiment, the device is a device for determining the temperature of a fluid line, a duct, a valve, a fluid reservoir, a heating unit and/or a cooling unit of a HVAC system.

Thereby, in particular, the temperature sensor is fixed on and/or inside a fluid line, a duct, a valve, a fluid reservoir, a heating unit and/or a cooling unit of a HVAC system. The fluid line and/or the duct for example are configured for conducting a gaseous and/or a liquid medium. Likewise, the valve and/or the fluid reservoir preferably is/are a valve or a reservoir, respectively, for a gaseous and/or a liquid medium.

Thereby, for example, the controller and/or the user interface, the machine interface and/or the data storage medium is/are spaced apart from the temperature sensor. In particular, the temperature sensor is connected to the controller via an electrical cable. This enables the other components to be kept under more constant conditions.

Preferably, the temperature sensor is clamped onto a fluid line, a duct, a valve, a fluid reservoir, a heating unit and/or a cooling unit of a HVAC system. This enables an easy but reliable installation.

A third aspect of the first exemplary embodiment is directed to a computer program comprising instructions to cause the device, preferably the room unit as described above, to execute the steps of any of the methods as described above or below.

A fourth aspect of the first exemplary embodiment is directed to a non-transient computer-readable medium (e.g., a memory) having stored thereon the computer program as described above.

A second exemplary embodiment of the present teachings is described in the following. The second exemplary embodiment, which can be implemented independently of the above-described first exemplary embodiment, is related to a method for determining a temperature in a heating, ventilation, and/or air conditioning system, comprising:
a) repeatedly measuring the temperature with a temperature sensor to acquire time-resolved raw temperature data;
b) processing the acquired raw temperature data with a correction algorithm that is configured for at least partly compensating for self-heating of the temperature sensor, at least in selected time periods, preferably using a computer processor, to provide processed temperature data; and
c) making available (electronically outputting) the processed temperature data via (to) a user interface, via (to) a machine interface and/or on (to) a data storage medium.

Advantages described above in connection with the features of the first exemplary embodiment are likewise given with regard to corresponding features of the second exemplary embodiment.

The correction algorithm of the second exemplary embodiment that is configured for at least partially compensating for self-heating of the temperature sensor is in essence identical in design with the above-described further correction algorithm described above in connection with the first exemplary embodiment. However, in case of the second exemplary embodiment, there is not necessarily another correction algorithm, which is configured to at least partially compensate for the response time of the temperature sensor at least in selected time periods. However, such a correction algorithm or any other correction algorithm may optionally be present, if desired.

Preferably, a self-heating temperature is calculated and subtracted from the raw temperature data acquired in step a).

In particular, the compensation for the self-heating is calculated taking into account at least one environmental parameter, preferably at least two environmental parameters. The at least one environmental parameter preferably is selected from ambient temperature, supply voltage, humidity, and/or airflow.

Preferably the at least one external (environmental) parameter is selected from ambient temperature and/or supply voltage: most preferably the at least one external parameter comprises at least two external parameters: especially preferred are the ambient temperature and the supply voltage.

For the ambient temperature, the most recent raw temperature or the most recent processed temperature can be used.

The supply voltage is meant to be a supply voltage of a device of the heating, ventilation, and/or air conditioning system, preferably a device of the HVAC system that comprises the temperature sensor. The device in particular is a room unit.

Preferably, the supply voltage is estimated based on an internal voltage of a device of the heating, ventilation, and/or air conditioning system, preferably the room unit. The internal voltage is meant to be the internal supply voltage at which the device of the HVAC system is operated.

The correction algorithm of the second exemplary embodiment that is configured for at least partially compensating for self-heating of the temperature sensor in particular is configured such that the compensation is linearly dependent on the at least one environmental parameter, preferably linearly dependent on at least two environmental parameters.

Preferably, the correction algorithm is configured such that the self-heating temperature T_{SH} is calculated according to the following formula (I):

$${T}_{SH} ( y , z ) = {p}_{00} + {p}_{10} y + {p}_{01} z \qquad ( I )$$

wherein:
p₀₀, p₁₀, and p₀₁ are constant coefficients;
y is a first environmental parameter, preferably the ambient temperature;
z is a second environmental parameter, preferably the supply voltage:

and wherein the calculated self-heating temperature T_{SH} is subtracted from the raw temperature data acquired in step a) and/or from the processed temperature data of step b).

This approach enables a reliable and precise self-heating compensation.

In particular, at least one or all parameters of the correction algorithm, preferably the constant coefficients p₀₀, p₁₀, and/or p₀₁, is/are selected and/or set depending on the specific environment in which the temperature sensor is located, in particular depending on the type and/or configuration of the room unit in which the temperature sensor is placed.

A second aspect of the second exemplary embodiment is directed to a device of a heating, ventilation, and/or air conditioning system comprising means adapted to execute the steps of any of the methods as described above or below. Thereby, the means in particular are adapted to execute such a method with one or more, preferably all, of the optional features as described above.

In particular, the “means adapted to execute the steps of the method as described above or below” comprise (i) a temperature sensor, (ii) a controller configured for executing the steps of any of the methods as described above or below, and (iii) a user interface, a machine interface and/or a data storage medium for making available the processed temperature data. Thereby, the controller in particular comprises a program with instructions to cause the device to execute the steps of any of the above- or below-described methods.

Preferably, the device is a room unit for an HVAC system. Preferably, the room unit comprises:
a) a housing preferably comprising a mounting plate for mounting the room unit on a wall of a building;
b) a connection means to connect the device to the HVAC system;
c) at least one temperature sensor to measure the temperature of ambient air; and
d) a controller configured for carrying out any of the methods as described above or below.

Preferably, the controller is arranged on a printed circuit board. Typical printed circuit boards are robust and can be fixed in the housing in a space saving manner.

Furthermore, in addition to the temperature sensor, the room unit preferably comprises at least another sensor to measure at least one further parameter of the ambient air, preferably humidity, the concentration of CO₂, volatile organic compounds (VOC) and/or particulate matter.

More preferably, the room unit comprises:
c) the controller arranged on a first printed circuit board; and
d) the at least one temperature sensor to measure the temperature of the ambient air, wherein the at least one temperature sensor is arranged on a frontside of a second printed circuit board: wherein the second printed circuit board protrudes from the first printed circuit board, preferably in a direction perpendicular to the first printed circuit board:
   wherein the second printed circuit board is arranged such that a backside of the second printed circuit board is in physical contact with an inner surface of the housing.

The combination of the at least one temperature sensor arranged on a frontside of a second printed circuit board, which protrudes from the first printed circuit board and which is in physical contact via its backside with the inner surface of the housing, turned out to be highly beneficial. With this setup the temperature sensor is thermally decoupled from the heat generating elements, e.g. microprocessors or other electronic components, which are part of the controller of the room unit. At the same time, the temperature of the housing of the room unit, which in essence corresponds to the temperature of the ambient air in the controlled room, space or zone is efficiently coupled to the second printed circuit board or the temperature sensor. In combination with any of the methods as described above or below, this enables even faster response times to be obtained when temperatures changes occur in the controlled room, space or zone.

Moreover, this setup enables the ambient room temperature to be accurately measured in essence independently of the heat evolution of the controller on the first printed circuit board.

Furthermore, this arrangement is obtainable with established (known) standard assembly methods for printed circuit boards. Put differently, there is no need for complex manufacturing processes or even manual labor. Hence, this arrangement can be produced in a highly efficient and cost effective manner.

Preferably, the second printed circuit board is fixed, preferably soldered on and/or plugged into, the first printed circuit board, in particular with at least one or more pin connectors. Preferably, there are at least two, three, or more pin connectors. Pin connectors preferably are electrical connectors. This enables a compact and mechanically stable connection between the two circuit boards. However, other setups are possible as well.

According to a preferred embodiment, the backside of the second printed circuit board comprises a heat conductive coating, which is in contact with the inner surface of the housing. In this case, the heat conductive coating of the second printed circuit board acts as a thermal bridge between the second printed circuit board and the housing. This greatly enhances the thermal coupling between the housing and the second printed circuit board or the temperature sensor, which in turn improves response times when temperatures changes occur in the controlled room, space or zone.

However, depending on the specific application, the coating can be omitted in order to simplify the setup.

Preferably, the heat conductive material is a material having a thermal conductivity (2) of at least 10 W/(m·K), preferably at least 100 W/(m·K), in particular at least 200 W/(m·K), wherein the thermal conductivity is measured at 0° C., at a pressure of 1.013 bar and a humidity of 50%.

Preferably, the heat conductive material is a metallic material, in particular comprising or consisting of copper, aluminum, silver and/or gold. These materials exhibit a relatively high thermal conductivity while being mechanically and chemically stable for use as a coating in the room unit. Nevertheless, other materials can be suitable as well.

If present, the coating of the heat conductive material preferably covers at least 50%, preferably at least 75%, in particular at least 90%, of the backside area of the second printed circuit board.

Preferably, the thickness of the coating of the heat conductive material is 0.001-1 mm, preferably 0.01-0.5 mm, in particular 0.02-0.05 mm.

This results in a highly effective thermal coupling between the housing and the second printed circuit board. However, the area share (ratio, portion) of the heat conductive coating can be below (less than) 50% and/or the thickness can be chosen differently, if desired for specific embodiments.

According to a further preferred embodiment, at least one humidity sensor to measure the humidity of the ambient air is additionally arranged on the second printed circuit board. Also for these kinds of sensors, reliable temperature conditions are important. Of course, the second printed circuit board might comprise further sensors.

In particular, a combined sensor for measuring temperature and humidity of the ambient air is arranged on the second printed circuit board. This results in a space-saving structure and an easier readout of the sensors.

Preferably, the at least one temperature sensor, the at least one humidity sensor and/or the combined sensor is/are an active sensor. In the present context, an active sensor is meant to be a sensor device that is powered with input energy from a source other than that which is being sensed for delivering an output signal. In contrast, a passive sensor works without input energy. If desired, the present teachings can be implemented with passive sensors as well.

In a further preferred embodiment, a further sensor for measuring a further parameter of the ambient air is arranged on the first printed circuit board: preferably, the further sensor is a sensor for measuring the concentration of CO₂, volatile organic compounds (VOC) and/or particulate matter. These kinds of sensors typically produce a considerable amount of heat during operation. Therefore, it is beneficial to arrange them on the first printed circuit board, i.e. thermally decoupled from the second printed circuit board comprising the temperature sensor.

However, a further sensor for measuring a further parameter of ambient air arranged on the first printed circuit board sensors is optional.

Preferably, the second printed circuit board is located at (along) an edge of the first printed circuit board. This enables the second printed circuit board to directly contact the inner surface of the housing by placing the first printed circuit board nearby the inner surface. Additionally, the second printed circuit board can be separated as far as possible from the heat generating components on the first printed circuit board. However, other setups are possible as well. For example, the second printed circuit board can be located on a more central section of the first printed circuit board. In this case, the housing might feature an inner bulge for contacting the second printed circuit board.

Preferably, with reference to an installed state of the room unit,
the controller is spaced in the horizontal direction from the second printed circuit board, wherein, preferably, in the horizontal direction the controller is located in the other half of the first printed circuit board than the second printed circuit board; and/or
the controller is spaced in the vertical direction from the second printed circuit board, wherein, preferably, the controller is located above the second printed circuit board; and/or
the second printed circuit board is located in a lower half of the first printed circuit board; and/or
if present, the further sensor for measuring a further parameter of ambient air, with reference to the installed state of the room unit, is arranged in a section of the first printed circuit board in the vertical direction above the second printed circuit board.

With these measures, the second printed circuit board can optimally be separated from heat generating components on the first printed circuit board. Thereby, if the second printed circuit board is located in the vertical direction below the heat generating components, ascending heat produced by these components will not flow around the second printed circuit board. Nevertheless, other setups are possible as well.

Preferably, in a first section of the first printed circuit board, in which the second printed circuit board is installed,
there is no metallic ground plane on or within the first printed circuit board; and/or
a surface area of metallic connection lines and/or metallic ground planes on or within the first printed circuit board is below (less than) 50%, preferably below 25%, in particular below 10%, relative to the total surface area of the first section; and/or
the first section is separated from a second section of the first printed circuit board, in which the controller is located, by at least one slit-shaped opening in the first printed circuit board, preferably for thermally decoupling the two sections.

In a further preferred embodiment, the first printed circuit board comprises a third section in which the at least one further sensor is located, whereby, the third section is separated from the first and/or the second section by at least one further slit-shaped opening in the first printed circuit board, preferably for thermally decoupling the third section from the first and/or the second section.

In the embodiments described above, the first section preferably has a surface share (ratio, portion) of 5-50%, preferably 7-30%, in particular 10-20%, relative to the total surface area of the first printed circuit board.

These measures, each one alone and even more in combination with each other, help to further thermally decouple the second printed circuit board from the first printed circuit board.

Preferably, the housing frame comprises a support structure, preferably a tray, for carrying (supporting) the controller or the printed circuit board, preferably the first printed circuit board, with the controller arranged on it within an inner volume surrounded by the side wall, preferably on a side of the support structure facing away from the wall and/or the mounting plate.

The support structure preferably defines a fixed position of the circuit boards in the housing. If the support structure is present in the above mentioned housing frame, the first printed circuit board with the second printed circuit board can be installed beforehand on the support structure and later on attached to the mounting plate. This greatly simplifies installation and maintenance.

Preferably, the support structure covers 50-100%, preferably 70-90%, of the cross-sectional area of the inner volume surrounded by the side wall of the housing frame. This enables the housing to be divided into two distinct volumes, such that, for example, the circuit boards can be protected against undesired forces during installation.

The printed circuit board, preferably the first printed circuit board, preferably comprises one or more pin connectors, in particular for connecting the controller to the connection means.

In this case, preferably, the mounting plate comprises the connection means to connect the device to the HVAC system, preferably a connector for a bus system, preferably a field bus system, and/or a socket which is configured for receiving the one or more pin connectors of the printed circuit board, preferably the first printed circuit board.

Most preferably, the pin connectors of the printed circuit board, preferably the first printed circuit board, and the connection means are configured such that the one or more pin connectors can be inserted or are inserted into the socket, preferably through openings in the support structure, preferably in a direction perpendicular to the mounting plate.

This enables an easy and safe installation since the printed circuit board, preferably the first printed circuit board, can simply be pressed onto the connection means to establish a connection.

The front housing part preferably is a separate part of the housing which is configured to be fixed on the housing frame, preferably with at least one snap-in connector.

According to a preferred embodiment, the front housing part comprises a display, preferably an electronic paper display, preferably covered with a transparent cover. This enables information concerning the set values and the measured parameters, such as the corrected temperature data, to be displayed.

Preferably, the display is a touchscreen or is overlaid with a touch sensitive foil. Such a display can be used as an input device for users to set values, such as e.g. a desired room temperature, ventilation intensity, etc.

In another preferred embodiment, the front housing part is a blind cover. In this case, no display is present and the room unit is intended to function without user input, or user input is provided via one or more other input devices, e.g. wireless communication modules.

Furthermore, the room unit preferably comprises a short-range wireless communication module which enables wireless communication with a mobile device for the exchange of data between the mobile device and the room unit, and vice versa.

Further preferred, the room unit comprises an antenna for wireless communication, preferably, an antenna of the above mentioned short-range wireless communication module.

Most preferably, the antenna is arranged behind the display, preferably in physical contact with the backside of the display. In particular the antenna can be in loose contact with the display or the antenna is attached to a backside of the display. In a special embodiment, the antenna is materially bonded to the backside of the display, preferably adhesively bonded to the backside of the display.

Arranging the antenna behind the display turned out to be highly beneficial. Thereby the antenna can be attached to the backside of the display. This simplifies installation and protects the antenna during installation and maintenance. Nevertheless, electromagnetic waves typically used for short-range wireless frequencies sufficiently penetrate displays that are usually used for room units. Additionally, the antenna is optimally placed in the room unit for establishing a reliable connection with a mobile device. As it turned out, users intuitively tend to hold a mobile device in front of a display. Thus, if the antenna is located behind the display, the chances of obtaining a reliable connection in a first attempt are highly improved. The arrangement of the antenna behind the display therefore results in a synergistic effect.

If the front housing part is a blind cover, the antenna preferably is in physical contact with or attached to the backside or the inner side of the blind cover.

Preferably the antenna is a planar antenna, preferably a microstrip antenna and/or a foil antenna, in particular comprising conductive antenna elements in and/or on a substrate in the form of a plastic foil. Such antennas are rather robust and compact.

Preferably, the outer dimensions of the antenna are equal to or smaller than the size of the display. Thus, in this case the antenna is fully covered by the blind cover or the display, resulting in maximum protection.

According to a further preferred embodiment, the antenna is a planar frame-shaped antenna, preferably with a shape and an outer dimension equal to the outer dimension of the display or the inner dimension of the blind cover. Antennas having such shapes can cover the whole area of the front housing part and/or the display and ensure a good connection with a mobile device even if it is positioned at (along) an edge of the housing and/or display.

In another embodiment, the antenna can have the form of a planar rectangular sheet.

Further preferred, the front housing part comprises a frame element for carrying (supporting) the display, the transparent cover, the touch sensitive foil, and/or the antenna, whereby, preferably, the frame element comprises snap-in connection means for connection the frame element to the housing frame. Such a frame element supports and protects the stack of components.

Preferably, the controller comprises a microcontroller or a microprocessor, as well as at least one memory. In the installed state, the controller is in particular electrically connected to the connection means, preferably via the pin connectors. If present, the controller furthermore can be connected to the display, the second printed circuit board, the at least one sensor and/or the at least one further sensor.

In particular, the controller is further configured to send data to and receive data from the HVAC system. Additionally, the controller can be configured to present data on the display, if present, and/or to read data from an input device, if present. The data comprises for example temperature data, humidity data, CO₂ data, data on particulate matter and/or ventilation data.

A third aspect of the second exemplary embodiment is directed to a computer program comprising instructions to cause the device, preferably the room unit, as described above or below, to execute the steps of any of the methods as described above or below.

A fourth aspect of the second exemplary embodiment is directed to a non-transient computer-readable medium having stored thereon the computer program as described above.

A third exemplary embodiment of the present teachings is described in the following. The third exemplary embodiment, which can be implemented independently of the above-described first exemplary embodiment and the above-described second exemplary embodiment, is related to a method for determining a temperature in a heating, ventilation, and/or air conditioning (HVAC) system, with the HVAC system comprising a room unit with connection means by which the room unit is connected to the HVAC system, with the connection means comprising input and output connections, in particular embodied as pin connectors, and wherein the method comprises:
a) Repeatedly measuring the temperature with a temperature sensor of the room unit to acquire time-resolved raw temperature data;
b) Processing the acquired raw temperature data with (using) a correction algorithm that is configured (written) to at least partly compensate for self-heating of the temperature sensor, with the processing providing processed temperature data and with the processing in particular comprising calculating a self-heating temperature and subtracting it from the raw temperature data;
c) Measuring observables related to at least some of the input connections and/or to at least some of the output connections of the room unit, which measured observables are indicative of an electrical power dissipated in the respective input connections and/or in the respective output connections, and further processing the processed temperature data with a further correction algorithm based on the measured observables, with the further processing providing compensated temperature data; and
d) Making available the compensated temperature data via a user interface, via a machine interface and/or on a data storage medium.

Advantages described above in connection with the features of the first exemplary embodiment and the second exemplary embodiment are likewise given with regard to corresponding features of the third exemplary embodiment.

The method of the third exemplary embodiment may also be implemented without step b), i.e. raw temperature data obtained in step a) may be directly processed with the further correction algorithm of step c).

The method of the third exemplary embodiment may also be implemented with step b) and step c) combined into one combined step b). Combined step b) may comprise processing the acquired raw temperature data with a combined correction algorithm, which combined correction algorithm may be based on the correction algorithm of step b) and the further correction algorithm of step c). The combined correction algorithm may, for example, correspond to a linear combination or a nonlinear combination of the outputs of the correction algorithm and the further correction algorithm; the combined correction algorithm may also receive as inputs the inputs of the correction algorithm and of the further correction algorithm and provide compensated temperature data by processing the inputs together (jointly).

The method of the third exemplary embodiment may also be implemented in a bifurcated manner. For example, in an intermediate step between step a) and combined step b) or step b), the method may determine whether input connections and/or output connections are active or inactive: in case they are inactive, the method may only comprise executing step b) directly followed by step d), i.e. step c) may be left out: in case they are active, the method may comprise executing step b) followed by steps c) and d), or the method may comprise executing combined step b) followed by step d).

Instead of subtracting the calculated self-heating temperature from the raw temperature data in step b), other operations may also be applied (performed) between the calculated self-heating temperature and the raw temperature data.

One non-limiting example of an observable according to the third exemplary embodiment may be one or more values, parameters, measurements, etc. that is/are indicative or representative of (e.g., proportional to) the amount of electrical power dissipated in the connection means of the room unit, which dissipated electrical power causes self-heating of the connection means. Currents flowing through the connection means, in particular through the pin connectors, cause Joule heating which in turn may influence the raw temperature data obtained by the temperature sensor. Voltages, i.e. electric potential differences, are related to current flows through conductive media. Accordingly, the observables may be, e.g., currents, or voltages, or electrical power. By taking into account such effects, the further correction algorithm may thereby further improve the accuracy of the temperature measurement and thereby enable an improved control over an environment to be controlled. In case the method of the third solution comprises a combined step b), the measured observable(s) may be provided as input(s) to the combined correction algorithm together with the first environmental parameter y, which is preferably the ambient temperature, and the second environmental parameter z, which is preferably the supply voltage, which would have been provided to the correction algorithm; i.e. the combined correction algorithm may provide the compensated temperature data, e.g., based on the measured observable(s), the first environmental parameter and the second environmental parameter. The room unit may be suitably modified to comprise measurement means (e.g., one or more sensors) needed for measuring the observable(s). Besides such additional measurement means, the room unit may be embodied as described in the first exemplary embodiment or in the second exemplary embodiment above. The further correction algorithm may be carried out by the controller.

The observables may be measured, for example, for those input connections and/or output connections in which current flows are expected which may in turn cause relevant self-heating. For output connections, in particular embodied as pin connectors, of the room unit, observables related to those pin connectors may be measured through which pin connectors the room unit may provide acquired data, e.g. temperature, relative humidity, CO₂, temperature setpoints, dew points or ventilation setpoints, to the HVAC system.

The method according to the third exemplary embodiment may also be combined with the response time compensation of the method according to the first exemplary embodiment.

In a further embodiment of the method according to the third exemplary embodiment, the observables are repeatedly measured, in particular at least at two different instances of time. The observables may be measured at the same sampling frequency as the raw temperature data, for example. Alternatively, the observables may also be measured at a reduced sampling frequency or at a higher sampling frequency. Preferentially, the observables related to at least some of the input connections and/or to at least some of the output connections are measured concurrently: if, for example, three observables related to three pin connectors are measured, the three observables are measured concurrently, the repeated measurement thereby providing three-tuples at different instances of time.

In a further embodiment of the method according to the third exemplary embodiment, the measured observables are related to electric potential differences over (across) the at least some output connections, and wherein the further correction algorithm comprises summing the measured observables to provide a summed variable V_{Sum} and providing the summed variable as an input to a polynomial model (function, equation) determining a further temperature offset T_{Power}, with the polynomial model in particular being embodied as T_{Power}=ΔV_{Sum}²+BV_{Sum} and with A and B being constant coefficients: in case the observables are repeatedly measured, the respective summed variables V_{Sum} are determined at different instances of time and filtered, in particular low-pass filtered, before being provided to the polynomial model, and with the further processing comprising subtracting the further temperature offset from the processed temperature data to provide the compensated temperature data. In case the method of the third solution comprises a combined correction algorithm, the combined correction algorithm may comprise the following model (function, equation), for example:

$${T}_{CV} ( y , z , {V}_{Sum} ) = {p}_{00} + {p}_{10} y + {p}_{01} z + {AV}_{Sum}^{2} + {BV}_{Sum} \qquad ( I )$$

wherein p₀₀, p₁₀, p₀₁, A and B are constant coefficients; y is a first environmental parameter, preferably the ambient temperature; z is a second environmental parameter, preferably the supply voltage; and V_{Sum} is a value as described above. The method may then comprise subtracting T_{CV} from the raw temperature data; besides subtracting, other operations between the raw temperature data and T_{CV} are feasible as well. The model used as part of the combined correction algorithm may, however, also be embodied differently.

Instead of only summing the measured observables to obtain a summed variable, the measured observables may also be first squared before being summed, or an absolute value of the measured observables may be taken before summing them: other forms of combining the measured observables into one variable are also possible, which one variable should be indicative or representative of (e.g., proportional to) the combined electrical power dissipation in those parts of the connection means which are related to the measured observables. Instead of electric potential differences, currents or electrical power may be directly measured and summed to provide the summed variable.

The constant coefficients of the polynomial model may be determined once during development of the room unit and hard-coded. Instead of using a polynomial of second order, polynomials of other degrees may alternatively be used as well, for example third-degree or fourth-degree polynomials. Instead of a polynomial, other mathematical functions are feasible as well; however: as an example, a lookup table may be employed.

Filtering, in particular low-pass filtering, the summed variables is optional: accordingly, the determined further temperature offset may also be subtracted directly from the processed temperature data or from the raw-temperature data in case step b) is not carried out. In case filtering is implemented, an exponentially weighted moving average filter may for example be applied to the summed variables. Instead of subtracting the determined further temperature offset from the processed temperature data or from the raw temperature data, other operations between the further temperature offset and the processed temperature data or the raw temperature data may also be carried out.

Any of the above-described or below-described exemplary embodiments may be preferably utilized in an HVAC system in order to make the HVAC more sensitive (responsive) to one or more of abrupt temperature changes and/or self-heating of the room unit. For example, the compensated temperature data, which has been compensated for an abrupt temperature change and/or self-heating, may be used by the HVAC system to control heating and/or air conditioning (cooling) operations. That is, instead of using the raw temperature data measured by a temperature sensor in the room unit, a controller of the HVAC system preferably uses compensated temperature data according to the present teachings to make decisions whether to start or stop a heating operation (e.g., performed by a furnace, boiler, electrical heater, etc.) and/or whether to start or stop a cooling operation (e.g., performed by an air conditioner or other cooling means. In this way, the HVAC system can be operated more responsively and/or with reduced energy consumption.

Other advantageous embodiments and combinations of features will be apparent to skilled persons from the detailed description below and the entirety of the claims.

### BRIEF DESCRIPTION OF THE DRAWINGS

In the drawings used to explain the embodiments:

FIG. 1 shows an exploded perspective view of a housing frame, a printed circuit board, a frame element, a planar frame-shaped antenna for wireless communication and an electronic paper display with touch functionality, for use in a room unit;

FIG. 2 shows a perspective view of the part of the housing frame of FIG. 1:

FIG. 3 shows a mounting plate comprising a base plate having a circumferential rim projecting away perpendicularly from the base plate for use in room unit together with the components of FIG. 1:

FIG. 4 shows a top (plan) view onto the upper surface of the mounting plate of FIG. 3 with two first protrusions protruding away from the outer surface of the rim;

FIG. 5 shows an intermediate state during the connection of the housing frame of FIG. 1 and the mounting plate of FIG. 3:

FIG. 6 shows a detailed view of the interlocking between the housing frame and the mounting plate in the intermediate state shown in FIG. 5:

FIG. 7 shows a detailed view of the interlocking between the housing frame and the mounting plate after pivoting the housing frame to the closed state:

FIG. 8 shows a printed circuit board comprising a first printed circuit board and a second printed circuit board protruding from an edge of the first printed circuit board in a direction perpendicular to the first printed circuit board;

FIG. 9 shows another view of the printed circuit board of FIG. 8:

FIG. 10 shows a top (plan) view on the printed circuit board of FIGS. 8 and 9 installed in the housing frame of FIG. 1 from the side opposite the mounting plate (without the frame element, antenna and display attached);

FIG. 11 shows a detailed view of the second printed circuit board from a face side;

FIG. 12 shows a perspective view of a room unit comprising the components as shown in FIGS. 1-11 in the assembled state:

FIG. 13 shows a further room unit comprising a blind cover as a front housing part instead of a display:

FIG. 14 shows a schematic representation of a method for determining a temperature in a HVAC system wherein a correction algorithm that is configured to at least partly compensate for a response time of the temperature sensor is implemented:

FIG. 15 shows a comparison of the response time of a temperature sensor with a partially compensated response time of the temperature sensor (solid line) and without compensation (dashed line);

FIG. 16 shows a comparison of three temperature profiles measured with the room unit of FIG. 12 and an additional reference sensor. The solid line represents the data as measured for comparison with a fast reference sensor having a very short response time. The dashed line (- - -) represents the raw data as measured with the room unit of FIG. 12, i.e. without processing with the correction algorithm. The dotted line (• • •) represents the temperature data after being processed with the correction algorithm that is configured to at least partially compensate for the response time of the temperature sensor:

FIG. 17 shows a schematic representation of a method for determining a temperature in a HVAC system wherein a correction algorithm that is configured to at least partially compensate for self-heating of the temperature sensor is implemented:

FIG. 18 shows the dependence of the self-heating temperature (T_{SH}) on the internal temperature and the voltage of the room unit of FIG. 12; and

FIG. 19 shows a schematic representation of a method for determining a temperature in a HVAC system wherein a correction algorithm for at least partially compensating for a response time of the temperature sensor and a further correction algorithm for least partially compensating for self-heating of the temperature sensor is implemented.

In the figures, the same components are given the same reference symbols.

### DETAILED DESCRIPTION OF THE INVENTION

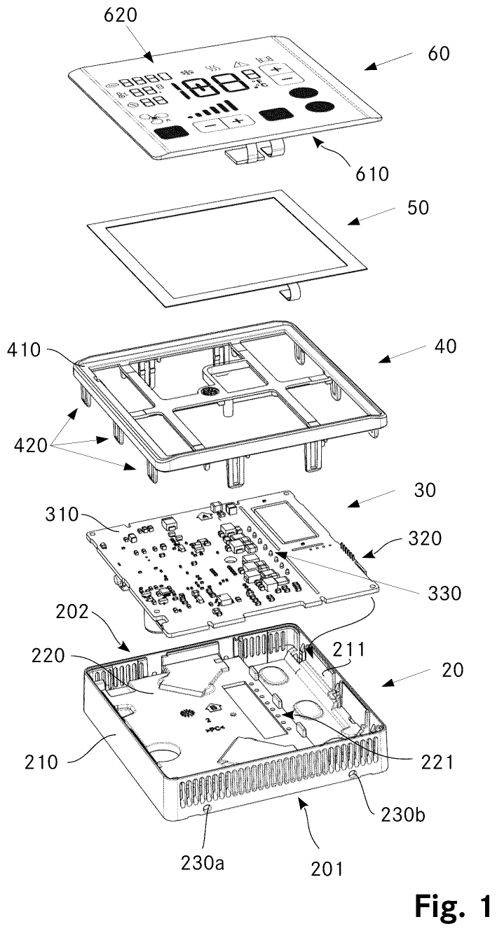

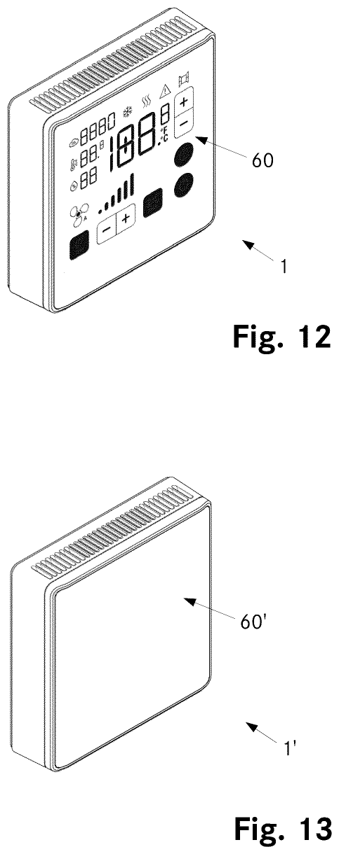

FIG. 1 shows an exploded view of a housing frame 20, a printed circuit board 30, a frame element 40, a planar frame-shaped microstrip antenna 50 for wireless communication and an electronic paper display 60 with touch functionality, which are components of a first room unit 1 as shown in FIG. 12.

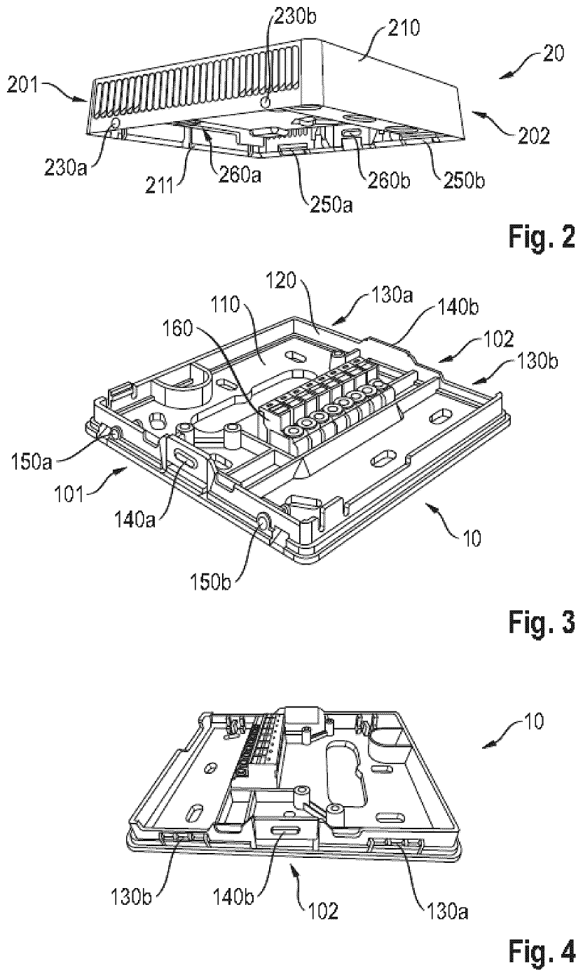

The housing frame 20 comprises a circumferential (peripheral) side wall 210 enclosing an inner volume of the housing frame 20. The side wall 210 comprises two bores 230a, 230b next to slit-shaped air vents at (in) a bottom side 201 (in the vertical direction with reference to the installed state) for fixing the housing frame 20 on a mounting plate 10 (see FIGS. 2-4). The upper side 202 (in the vertical direction with reference to the installed state) opposing the bottom side 201 comprises further slit-shaped air vents.

The inner volume of the housing frame 20 is divided into a lower part and an upper part with a tray-like support structure 220 having several breakthroughs for receiving (mounting) the printed circuit board 30.

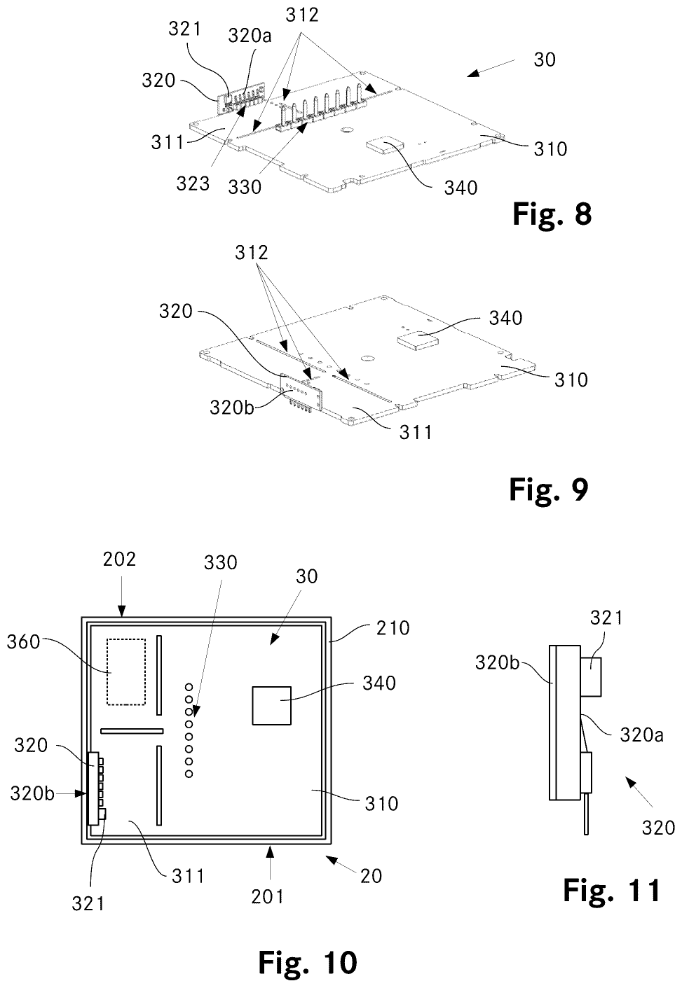

The printed circuit board 30 comprises a first printed circuit board 310 and a second printed circuit board 320 protruding from an edge of the first printed circuit board 310 in a direction perpendicular to the first printed circuit board 310. In a central part, there are 8 pin connectors 330 protruding in a direction towards the housing frame 20 (in FIG. 1 only the backside ends of the pin connectors are visible). Further details of the printed circuit board 30 and the arrangement in the housing frame 20 are given in FIGS. 8-11.

A section of the inner surface 211 of the side wall 210 of the housing frame 20 is configured for contacting the second printed circuit board 320 in the assembled state. In a central part of the support structure 220 there are 8 circular openings 221 for passing through the pin connectors 330 of the printed circuit board. Other breakthroughs are present for accommodating bulky electronic components of the printed circuit board 30.

The frame element 40 comprises a circumferential (peripheral) edge 410 as well as several supporting ribs and is configured for receiving (holding) the planar frame-shaped microstrip antenna 50 and the touchscreen display 60. In the assembled state, the antenna 50 is located at (on) the backside 610 of the display 60 in physical contact with it. The outer dimensions of the antenna 50 are in essence identical to the outer dimensions of the display 60. A stack consisting of the antenna 50 and the display 60 can be materially bonded to the frame 40. The frame 40 then can be attached to the housing frame 20 with ten snap-in connectors 420 that can respectively engage with corresponding counterparts at (in) the inner surface 211 of the side wall 210.

Frame element 40 and display 60 together form a front housing part.

FIG. 2 shows a view of the housing frame 20 opposite the printed circuit board 30. At (in) the inside of the upper side 202, the side wall 210 comprises two wedge-shaped protrusions, 250a, 250b projecting away from the inner surface of the side wall 210 towards an opposite inner surface of the housing frame 20.

Furthermore, there is a connection element 260b in the form of a recess between the two protrusions 250a, 250b, which is part of a mechanical snap-in connector for fixing the housing frame 20 to the mounting plate 10. At (on) the side opposite of the protrusions 250a, 250b, there is a further connection element 260a, which is identical in design.

FIG. 3 shows a mounting plate 10 comprising a square base plate 110 having a circumferential (peripheral) rim 120 projecting away perpendicularly from the base plate 110, wherein the rim is offset inwards from a circumferential edge of the base plate 110 by approximately the thickness of the side wall 210 of the mounting frame 20. The side wall 210 is configured for receiving the rim 120 of the mounting plate 10 with a positive fit.

At (on) the bottom side 101 (in the vertical direction with reference to the installed state) of the rim 120, there are two headless screws 150a, 150b arranged in a nut behind the rim 120, wherein in a first position as shown in FIG. 3, the screws 150a, 150b are fully located below an outer surface of the rim 120 of the mounting plate 10. If the rim 120 of the mounting plate 10 is received in the housing frame 20 and the screws 150a, 150b are brought into a second position, in which the screws 150a, 150b protrude outside the outer surface of the rim 120 into the corresponding bores 230a, 230b, the housing frame 20 is additionally secured to the mounting plate 10 in the assembled state.

Additionally, in a central part of the bottom side 101 of the rim 120 there is a connection element 140a in the form of a bulge, which is configured to engage with the connection element 260a of the housing frame 20. Thereby, the connection elements 140a, 260a form a snap-in connector.

At (in, on) the central part of the upper side 102 (in vertical direction with reference to the installed state) of the rim 120, there is a further connector element 140b, which is identical in design to and configured to engage with the connection element 260b of the housing frame 20, thus forming another snap-in connector.

The sections of the side wall 210 comprising the connector elements 260a, 260b are configured as a break-out section.

At (on) the upper side 102 of the rim, which is opposed to the bottom side 101, there are two spaced wedge-shaped protrusions 130a, 130b (not visible in FIG. 3: cf. FIG. 4) projecting away from an outer surface of the rim 120 in a direction parallel to the base plate 110.

Within the context of the present teachings, protrusions 130a, 130b are called “first protrusions” and protrusions, 250a, 250b are called “second protrusions”.

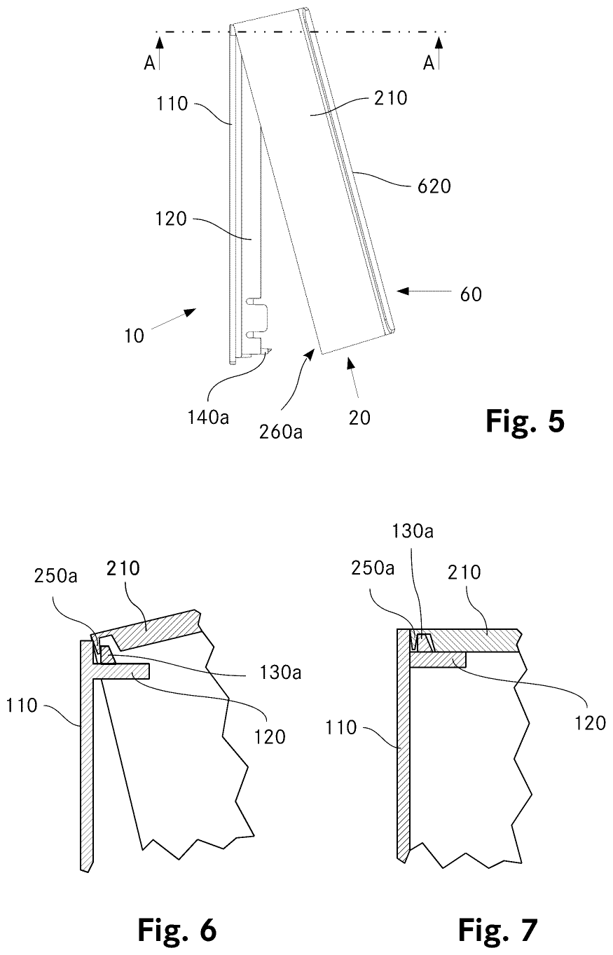

The first protrusions 130a, 130b of the base plate and the respective second protrusions 250a, 250b of the housing frame 20 are configured such that they can interlock with each other with a positive fit when the rim 110 of the mounting plate 10 is at least partly received in the circumferential side wall 210 of the mounting frame 20 (see FIGS. 5-7 for more details).

The sections of the rim 120 comprising the connector elements 140a, 140b are configured as break-out sections, each with two predetermined breaking points.

Additionally, there is a socket 160 which is configured for receiving pin connectors 330 of the printed circuit board 30. They can be inserted into the socket 160 through the circular openings 221 in the support structure 220 in a direction perpendicular to the mounting plate 10.

FIG. 4 shows a top (plan) view onto the upper surface 102 of the mounting plate 10, showing the first protrusions 130a, 130b protruding away from an outer surface of the rim 120 in a direction parallel to the base plate 110, i.e. in FIG. 4 into (toward) the direction of the viewer.

FIG. 5 shows an intermediate state during the connection process of the housing frame 20 and the mounting plate 10. Thereby, the components 30, 40, 50 and 60 have been attached to the housing frame 20 and the mounting plate 10 has been fixed on a wall of a building (not shown) beforehand. Specifically, the second protrusions 250a, 250b of the housing frame 20 are hooked onto the first protrusions 130a, 130b protruding in the vertical direction from the upper side of the rim 120 of the mounting plate 10. Thereby, the housing frame stands off at an angle relative to the base plate 110 at an angle of for example 25°.

FIG. 6 shows a detailed view of the interlocking between the first protrusion 130a and the second protrusion 130b in a cross-section of the upper left corner along line A-A of FIG. 5.

Thereafter, the housing frame 20 is pivoted around the interlocked protrusions 130a, 130b, 250a, 250b until the connection elements 140a, 260a, i.e. the snap-in connector, engage and, together with the interlocked connection elements 140a, 260a, secure the housing frame 20 to the mounting plate 10. A corresponding detailed view of this situation (mounting state) is shown in FIG. 7. Thereafter, the housing frame 20 can be further secured with the screws 150a, 150b by bringing them into engagement with the bores 230a, 230b. In FIG. 12 a perspective view of the resulting room unit 1 in assembled state is shown.

In order to enable the pivoting motion, tolerances for the positive fit between the side wall 210 and the rim 120 of the mounting plate 10 are chosen accordingly. Furthermore, the tolerances allow for pressing the housing frame in a direction perpendicular to the mounting plate 10, such that the protrusions 130a, 130b, 250a, 250b and the connection elements 140a, 260a can slip-over without prior hooking.

FIGS. 8 and 9 show the printed circuit board 30 from different perspectives. As already mentioned, the printed circuit board 30 comprises the first printed circuit board 310 and the second printed circuit board 320 that protrudes from an edge of the first printed circuit board 310 in a direction perpendicular to the first printed circuit board 310. The second printed circuit board 320 is, for example, soldered to the first printed circuit board with pin connectors.

On the first printed circuit board 310, a controller 340 comprising a microprocessor and a memory is arranged, whereas on the front side 320a of the second printed circuit board 320, a combined sensor 321 for measuring the temperature and humidity of the ambient air is arranged.

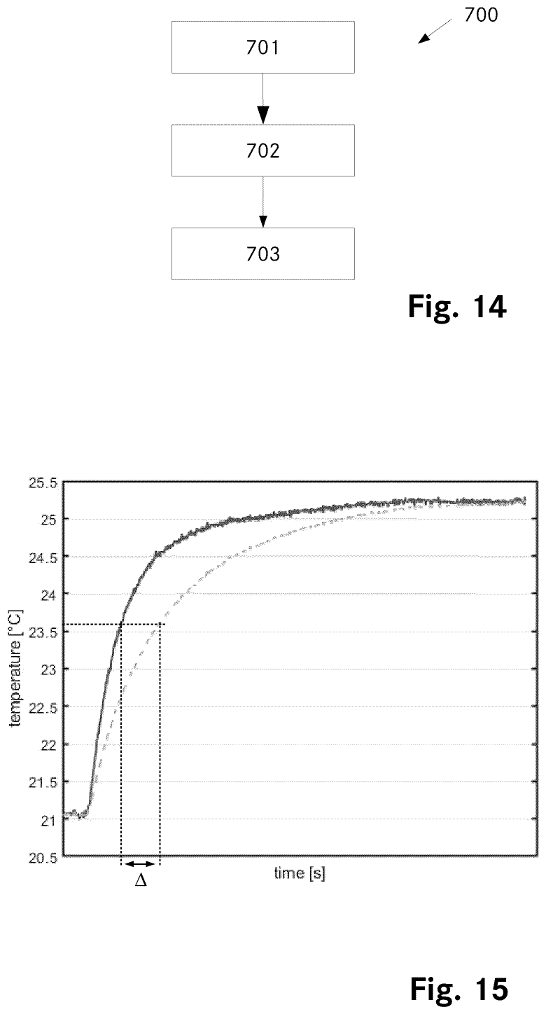

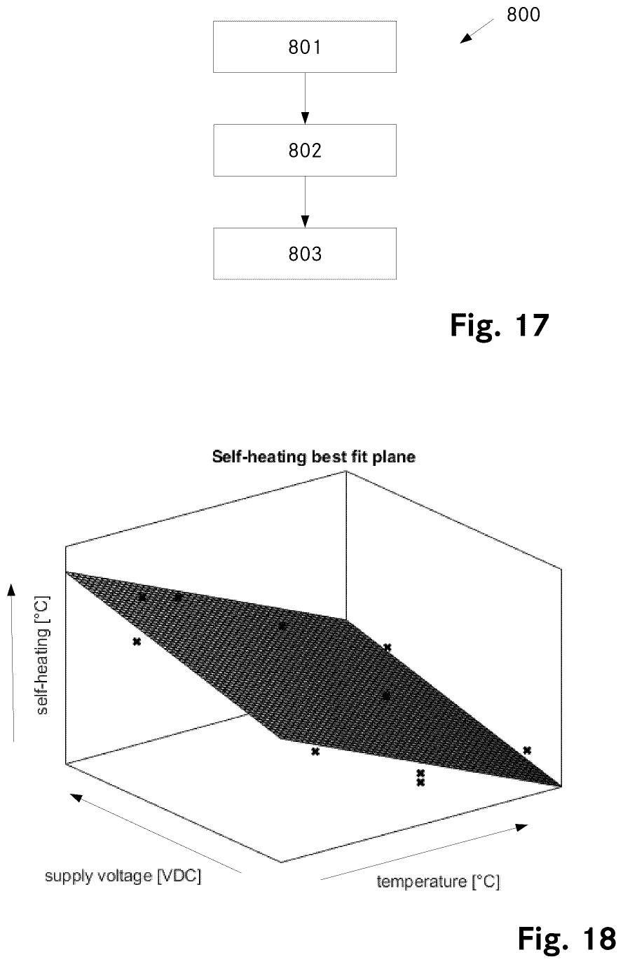

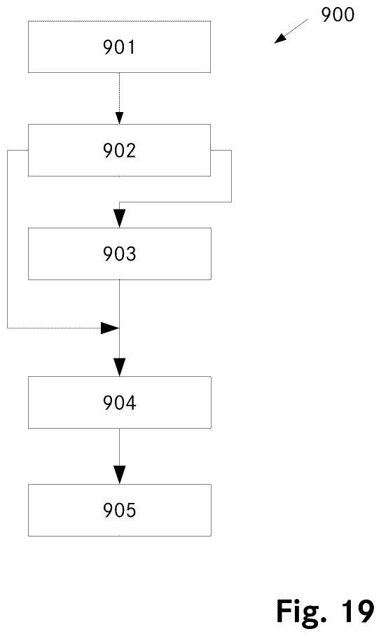

The controller 340 is configured for carrying out one or more methods or programs. For example, a first method is method 700 described below in connection with FIGS. 14-16. A second method is, e.g., method 800 described below in connection with FIGS. 17-18 and a third method is, for example, method 900 described below in connection with FIG. 19. Specifically, the controller 340 comprises appropriate programs to run these methods.

In a central part, there are 8 pin connectors 330 protruding in a direction perpendicular to the first printed circuit board 310.

A first section 311 of the first printed circuit board 310, in which the second printed circuit board is installed, is separated from the section comprising the controller 340 by slit-shaped openings 312 for thermally decoupling the two sections.

The backside 320b of the second printed circuit board 320 is coated with a copper coating having a thickness of, for example, 35 μm in essence on (over) the entire surface area.

FIG. 10 shows a top (plan) view of the printed circuit board 30 installed in the housing frame 20 from the side opposite the mounting plate (without the frame element 40, antenna 50 and display 60 attached). In the lower left corner in FIG. 10, the backside 320b of the second printed circuit board 320 is in physical contact with the inner surface of the side wall 210 of the housing frame 20 in order to achieve a thermal coupling. If desired, a further sensor 360, e.g. a CO₂ sensor, can be arranged in section 311, which preferably is isolated from the second printed circuit 320 and the controller 340 by a slit-shaped opening.

If the room unit is installed as intended with the bottom surface 201 of the housing pointing towards the floor and the upper surface 202 pointing towards the ceiling of the building, any ascending heat produced by the controller 340 and the optional further sensor will not flow around the second printed circuit board 320.

FIG. 11 shows a detailed view of the second printed circuit board 320 from a face side.

FIG. 12 shows a perspective view of the room unit 1 comprising the components as shown in FIGS. 1-11 in the assembled state.

FIG. 13 shows a further room unit 1′, which is in essence identical in design with room unit 1. However, instead of a display 60, the room unit 1′ comprises a blind cover 60′.

FIG. 14 shows a schematic representation of a method 700 for determining a temperature in a heating, ventilation, and/or air conditioning system. The method is for example performed with the above described room unit 1.

The method 700 comprises a step 701 of repeatedly measuring the temperature with (using) a temperature sensor, e.g. combined sensor 321 as described above, to acquire time-resolved raw temperature data.

The raw temperature data acquired in step 701 then is processed (by the controller 340) in a next step 702 with a correction algorithm that is configured to at least partially compensate for the response time of the temperature sensor to provide processed temperature data. The correction algorithm is a recursive filter, which is implemented in line with the above described formula (II):

$${u}_{c} ( n ) = {a}_{0} x ( n ) + {a}_{1} x ( n - 1 ) + {b}_{1} {u}_{c} ( n - 1 ) \qquad ( II )$$

wherein:
u_{c}(n) is the latest value of the processed temperature data;
a₀, a₁ and b₁ are recursion coefficients;
x(n) is the latest value of the time-resolved raw temperature data;
x(n−1) is the previous value of the time-resolved raw temperature data; and
u_{c}(n−1) is the previously calculated temperature value.

Thereby, the recursion coefficients a₀, a₁ and b₁ were defined according to the following formulas (III), (IV), and (V):

$${a}_{0} = \frac{2 T + {T}_{S}}{2 α T + {T}_{S}} \qquad ( III )$$

$${a}_{1} = \frac{2 T - {T}_{S}}{2 α T + {T}_{S}} \qquad ( IV )$$

$${b}_{1} = \frac{2 α T - {T}_{S}}{2 α T + {T}_{S}} \qquad ( V )$$

Thereby, the temperature response time T of the temperature sensor was determined experimentally with the sensor mounted in room unit 1. In the present example, T=8 minutes. The sampling rate T_{S} was set to 5 seconds. The acceleration factor α was set to 0.4.

In step 703, the processed temperature data is made available via a user interface, e.g. the electronic paper display 60 of room unit 1, and is transmitted via socket 160 and electrical cables to a central unit of the HVAC system.

Method 700 represents an example of the first exemplary embodiment of the present teachings. It should be noted that the temperature response time T as used in the correction algorithm is dependent on the specific room unit. For example, if the temperature sensor is replaced by another sensor without a CO₂ sensing unit, or if the display is replaced by a blind cover, or if a housing with a different structure is used, the temperature response time T needs to be determined for these configurations separately.

FIG. 15 shows the effect of the processing in step 702. Therein, the lower curve shows the evolution of the temperature reading of the temperature sensor without correction upon a step-like increase of the ambient temperature from about 21° C. to about 25° C. In FIG. 15, the time required for the sensor to indicate a temperature of 23.69° C. (i.e. 63.2% of the step-like increase of the ambient temperature) is for example about 8 minutes (=uncorrected response time T).

However, if the raw data is processed with the correction algorithm as described above, the response time can be significantly reduced. Put differently, the time required for the sensor to indicate the temperature of 23.69° C. (i.e. 63.2% of the step-like increase of the ambient temperature) in this example is only about 4.8 minutes (=corrected response time). Thus, thanks to the above-described processing of the acquired raw temperature data with the correction algorithm, more than a 35% reduction (A) of the response time can be achieved in essence without losing accuracy.

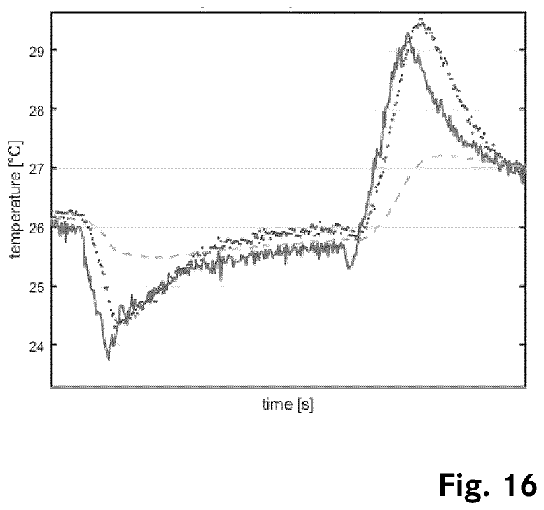

FIG. 16 shows three temperature profiles measured with the room unit 1 and an additional reference sensor. The solid line represents the data as measured for comparison with a fast reference sensor having a very short response time. The dashed line (- - -) represents the raw data as measured with the room unit 1, i.e. without processing with the correction algorithm. The dotted line (•••) represents the temperature data after being processed with the correction algorithm that is configured to at least partially compensate for the response time of the temperature sensor. As is evident, the temperature curve (dotted line) obtained with the correction algorithm follows quite closely to the temperature curve (solid line) obtained with the fast reference sensor. Thus, the present method makes it possible to at least partially compensate for the response time of the temperature sensor solely based on the raw measurement data.

FIG. 17 shows a schematic representation of a method 800 for determining a temperature in a heating, ventilation, and/or air conditioning system. The method is, for example, performed with the above described room unit 1.

The method 800 comprises a step 801 of repeatedly measuring the temperature with (using) a temperature sensor, e.g. combined sensor 321 as described above, to acquire time-resolved raw temperature data.

The raw temperature data acquired in step 801 then is processed (by the controller 340) in a next step 802 with a correction algorithm that is configured to at least partially compensate for self-heating of the temperature sensor, at least in selected time periods, to provide processed temperature data. Specifically, the correction algorithm is configured such that the self-heating temperature T_{SH} is calculated according to the following formula (I):

$${T}_{SH} ( y , z ) = {p}_{00} + {p}_{10} y + {p}_{01} z \qquad ( I )$$

wherein:
p₀₀, p₁₀, and p₀₁ are constant coefficients, which have been determined experimentally for room unit 1 (p₀₀=0.2424, p₁₀=−0.008125, p₀₁=0.01109);
y is a first environmental parameter, namely the ambient temperature; and
z is a second environmental parameter, namely the internal voltage of the room unit 1;
and wherein the calculated self-heating temperature T_{SH} is subtracted from the raw temperature data.

In step 803, the processed temperature data is made available via a user interface, e.g. the electronic paper display 60 of room unit 1, and is transmitted via socket 160 and electrical cables to a central unit of the HVAC system.

Method 800 represents an example of the second exemplary embodiment of the present teachings, which can be implemented independently of the first exemplary embodiment, if desired.

It should be noted that self-heating is dependent on the specific room unit. For example, if the temperature sensor is replaced by another sensor without a CO₂ sensing unit, or if the display is replaced by a blind cover, or if a housing having a different structure is used, the constant coefficients p₀₀, p₁₀, and p₀₁ need to be determined for these configurations separately.

FIG. 18 shows the dependence of the self-heating temperature (T_{SH}; axis values increase in the direction of the arrow) on the internal supply voltage of the room unit (axis values increase in the direction of the arrow) and the temperature considered in the above-mentioned formula (I) (y; axis values increase in the direction of the arrow).

As is evident, the higher the temperature, the lower the self-heating. In contrast, the higher the internal voltage, the higher the self-heating. Specifically, in a temperature window of about 50° C. (=coverage of temperature axis), the self-heating temperature increases in the range of a few tenths of a degree when the supply voltage is increased by 10-15 volts.

FIG. 19 shows a schematic representation of a further method 900 for determining a temperature in a heating, ventilation, and/or air conditioning system. The method 900 is performed with the above described room unit 1.

Method 900 comprises a step 901 of repeatedly measuring the temperature with (using) a temperature sensor, e.g. combined sensor 321 as described above, to acquire time-resolved raw temperature data.

In step 902, the variance (=statistical parameter) of a set of several most recent temperature values from the raw temperature data is calculated (by the controller 340) and compared with a predefined threshold. Thereby,
(i) in time periods in which the variance of the set is equal to or above (greater than) a predefined threshold, the acquired raw temperature data is compensated for the response time of the temperature sensor in step 903. Step 903 is in essence identical to the above described step 702 of the method shown in FIG. 14. After processing the raw temperature data in step 903, the processed data is further processed in step 904.
(ii) in other time periods, in which the variance of the set is below (less than) the predefined threshold, the acquired raw temperature data is not processed in step 903: i.e. there is no compensation of the response time of the temperature sensor. In this case, step 903 is bypassed and the raw data is directly processed in step 904.

In step 904, the raw temperature data or the temperature data processed in step 903 is further processed (by the controller 340) with a further correction algorithm which is configured such that the self-heating temperature T_{SH} is calculated similar to step 802 of method 800 described above and then the calculated self-heating temperature T_{SH} is subtracted from the raw temperature data or the temperature data processed in step 903.

In step 905, the processed temperature data is made available via a user interface, e.g. the electronic paper display 60 of room unit 1 and/or transmitted via socket 160 and electrical cables to a central unit of the HVAC system.

Thus, method 900 works similarly to method 700 and represents another example of the first exemplary embodiment of the present teachings. However, in method 900, the correction algorithm that is configured to at least partially compensate for the response time of the temperature sensor can selectively be switched on and off, depending on the variance of the raw temperature data. Furthermore, the temperature is additionally corrected by subtracting the self-heating temperature. This results in a highly efficient and precise determination of the temperature.

Thus, it will be appreciated by those skilled in the art that the present teachings can be embodied in other specific forms without departing from the spirit or essential characteristics thereof. The presently disclosed embodiments are therefore considered in all respects to be illustrative and not restricted.

In summary, it is to be noted that the present teachings provide highly beneficial methods and devices for determining temperatures in an HVAC system.

1. A method for determining a temperature in a heating, ventilation, and/or air conditioning system, comprising:
a) repeatedly measuring the temperature with a temperature sensor to acquire time-resolved raw temperature data;
b) processing the acquired raw temperature data with a correction algorithm that is configured to at least partially compensate for a response time of the temperature sensor, at least in selected time periods, using a computer processor to generate processed temperature data; and
c) electronically outputting the processed temperature data to a user interface, a machine interface and/or a data storage medium.

2. The method according to claim 1, further comprising calculating a statistical parameter of a set of several most recent temperature values from the raw temperature data;
wherein the correction algorithm is configured such that:
(i) in time periods in which the statistical parameter of the set is equal to or above a predefined threshold, the acquired raw temperature data is at least partially compensated for the response time of the temperature sensor in step b); and
(ii) in other time periods, in which the statistical parameter of the set is below the predefined threshold, the acquired raw temperature data in step b) is less compensated for the response time of the temperature sensor than under item (i), or the acquired raw temperature data in step b) is not compensated for the response time of the temperature sensor.

3. The method according to claim 1, further comprising further processing the raw temperature data acquired in step a) and processed in step b) and/or the processed temperature data of step b) with a further correction algorithm that is configured to at least partially compensate for self-heating of the temperature sensor.

4. The method according to claim 3, further comprising calculating a self-heating temperature and subtracting the self-heating temperature from the raw temperature data acquired in step a) and processed in step b) and/or from the processed temperature data of step b).

5. The method according to claim 3, wherein:
the compensation for the self-heating is calculated taking into account at least one environmental parameter and
the at least one environmental parameter is ambient temperature, supply voltage, humidity, and/or airflow.

6. The method according to claim 3, wherein the further correction algorithm is configured such that the compensation is linearly dependent on the at least one environmental parameter.

7. The method according to claim 3, wherein the further correction algorithm is configured such that a self-heating temperature T_{SH} is calculated according to the following formula (I):
$${T}_{SH} ( y , z ) = {p}_{00} + {p}_{10} y + {p}_{01} z \qquad ( I )$$
wherein:
p₀₀, p₁₀, and p₀₁ are constant coefficients;
y is a first environmental parameter;
z is a second environmental parameter; and
the calculated self-heating temperature T_{SH} is subtracted from the raw temperature data acquired in step a) and processed in step b) and/or from the processed temperature data of step b).

8. The method according to claim 1, wherein in time periods other than the selected time periods of step b) in which the acquired raw temperature data is processed with the correction algorithm that is configured to at least partially compensate for the response time of the temperature sensor, the processed temperature in step b) is set equal to the raw temperature data and/or to the raw temperature data processed with the further correction algorithm.

9. The method according to claim 1, wherein the correction algorithm that is configured to at least partially compensate for the response time of the temperature sensor is a recursive filter.

10. The method according to claim 1, wherein, at least in the selected time periods, a latest value of the processed temperature data is calculated based on:
(i) the latest value of the time-resolved raw temperature data or the latest value of the time-resolved raw temperature data processed with the further correction algorithm, and
(ii) at least one previous temperature value of the processed temperature data and/or at least one previous temperature value of the time-resolved raw temperature data or at least one previous temperature value of the time-resolved raw temperature data processed with the further correction algorithm.

11. The method according to claim 9, wherein the latest value u_{c}(n) of the processed temperature data is calculated based on the following formula (II):
$${u}_{c} ( n ) = {a}_{0} x ( n ) + {a}_{1} x ( n - 1 ) + {b}_{1} {u}_{c} ( n - 1 ) \qquad ( II )$$
wherein:
a₀, a₁ and b₁ are recursion coefficients;
x(n) is the latest value of the time-resolved raw temperature data or the latest value of the time-resolved raw temperature data processed with the further correction algorithm;
x(n−1) is the previous value of the time-resolved raw temperature data or the previous value of the time-resolved raw temperature data processed with the further correction algorithm; and
u_{c}(n−1) is the previously calculated temperature value.

12. The method according to claim 11, wherein the recursion coefficients a₀, a₁ and b₁ are determined by (i) the response time of the temperature sensor in a given environment, (ii) a sampling rate of the temperature sensor and/or (iii) a desired accelerator factor of the response time of the response time of temperature sensor.

13. The method according to claim 11, wherein a₀, a₁ and b₁ are defined according to the following formulas (III), (IV), and (V):
$${a}_{0} = \frac{2 T + {T}_{S}}{2 α T + {T}_{S}} \qquad ( III )$$
$${a}_{1} = \frac{2 T - {T}_{S}}{2 α T + {T}_{S}} \qquad ( IV )$$
$${b}_{1} = \frac{2 α T - {T}_{S}}{2 α T + {T}_{S}} \qquad ( V )$$
wherein:
T=the response time of the temperature sensor in a given environment;
T_{S}=sampling rate of the temperature sensor; and
α=accelerator factor, wherein 0<α<1.

14. A device of a heating, ventilation, and/or air conditioning system comprising:
(i) a temperature sensor configured to measure the temperature of ambient air,
(ii) a controller comprising a program having instructions that cause the device to execute the steps of the method of claim 1 to generate the processed temperature data, and
(iii) a user interface, a machine interface and/or a data storage medium configured to electronically receive the processed temperature data from the controller.

15. The device according to claim 14, wherein the device is a room unit for an HVAC system and further comprises:
a) a housing comprising a mounting plate configured to mount the room unit on a wall of a building; and
b) a connection means for connecting the device to the HVAC system.

16. The room unit according to claim 15 wherein the housing comprises a user interface having a display configured to visually present the corrected temperature data.

17. A non-transitory computer readable medium storing instructions that, when executed, cause an electronic device to:
repeatedly measure a temperature with a temperature sensor to acquire time-resolved raw temperature data;
process the acquired raw temperature data with a correction algorithm that is configured to at least partially compensate for a response time of the temperature sensor, at least in selected time periods, to generate processed temperature data; and
electronically output the processed temperature data to a user interface, a machine interface and/or a data storage medium.

18. A method for determining a temperature in a heating, ventilation, and/or air conditioning (HVAC) system, the HVAC system comprising a room unit having a connection means by which the room unit is connectable (connected) to the HVAC system, the connection means comprising input and output connections, the method comprising:
a) repeatedly measuring the temperature with a temperature sensor of the room unit to acquire time-resolved raw temperature data;
b) processing the acquired raw temperature data using a computer processor that executes a correction algorithm that is configured to at least partly compensate for self-heating of the temperature sensor, the processing providing processed temperature data by calculating a self-heating temperature and correcting the raw temperature by subtracting the self-heating temperature from the raw temperature data;
c) measuring one or more observables related to at least some of the input connections and/or to at least some of the output connections of the room unit, the measured observable(s) being indicative of an amount of electrical power dissipated in the respective input connections and/or in the respective output connections, and further processing the processed temperature data using the computer processor with a further correction algorithm based on the measured observables, whereby the further processing provides compensated temperature data; and
d) electronically outputting the compensated temperature data to a user interface, a machine interface and/or a data storage medium.

19. The method according to claim 18, wherein the observable(s) is (are) repeatedly measured at least at two different instances of time.

20. The method according to claim 18, wherein:
the measured observable(s) is (are) related to or representative of electric potential differences over (across) the at least some output connections,
the further correction algorithm comprises summing the measured observable(s) to provide a summed variable V_{Sum} and providing the summed variable as an input to a polynomial model that determines a further temperature offset T_{Power},
the polynomial model is embodied as T_{Power}=AV_{Sum}²+BV_{Sum} in which A and B are constant coefficients, and
the further processing comprises subtracting the further temperature offset from the processed temperature data to provide the compensated temperature data.

21. The method according to claim 1, further comprising controlling the heating, ventilation, and/or air conditioning system using the processed temperature data.

22. The method according to claim 7, wherein the first environmental parameter is the ambient temperature and the second environmental parameter is a supply voltage.
